(19) United States
(12) Patent Application Publication
(10) Pub. No.: US 2026/0000085 A1
(43) Pub. Date: Jan. 1, 2026

(54) PICKERING EMULSION FOR COATING ENTOMOPATHOGENIC NEMATODES

(71) Applicants: THE STATE OF ISRAEL, MINISTRY OF AGRICULTURE & RURAL DEVELOPMENT, AGRICULTURAL, Rishon Lezion (IL); THE UNITED STATES OF AMERICA, AS REPRESENTED BY THE SECRETARY OF AGRICULTURE, Washington, DC (US); UNIVERSITY OF GEORGIA RESEARCH FOUNDATION, INC., Athens, GA (US)

(72) Inventors: Dana MENT, Ness Ziona (IL); Guy MECHREZ, Adi (IL); Liliya KARASIK, Rehovot (IL); Jayashree RAMAKRISHNAN, Rishon Lesion (IL); David I. SHAPIRO-ILAN, Macon, GA (US); Shaohui WU, Columbus, OH (US)

(21) Appl. No.: 18/880,708

(22) PCT Filed: Jul. 5, 2023
(86) PCT No.: PCT/IL2023/050697

§ 371 Date: Jan. 2, 2025

Related U.S. Application Data
(60) Provisional application No. 63/358,387, filed on Jul. 5, 2022.

(51) Int. Cl. A01N 63/12; A01N 25/04; A01P 7/04

(52) U.S. Cl. CPC A01N 63/12; A01N 25/04; A01P 7/04

(57) ABSTRACT

Provided herein is a composition comprising a Pickering emulsion comprising a plurality of core-shell particles encapsulating an entomopathogenic organism. Furthermore, a method for controlling a pest on or within a plant or at the area under cultivation is provided.

### CROSS REFERENCE TO RELATED APPLICATIONS

This application claims the benefit of priority to U.S. Provisional Patent Application No. 63/358,387 filed Jul. 5, 2022, entitled “PICKERING EMULSION FOR COATING ENTOMOPATHOGENIC NEMATODES” the contents of which are incorporated herein by reference in their entirety.

### FIELD OF THE INVENTION

The present invention is in the field of Pickering emulsions, specifically compositions comprising an entomopathogenic organism coated by colloidosomes.

### BACKGROUND OF THE INVENTION

Chemical pesticides are used to destroy, repel or mitigate arthropod pests. Broad-spectrum chemical pesticides are often harmful to the environment, humans and other nontarget organisms. In contrast to the chemical pesticides, biological pesticides (biopesticides) are natural, biodegradable, eco-friendly and tend to have minimal effects on nontarget organisms. Entomopathogenic nematodes (EPNs) are microbial control agents which have become important and play a major role in biological control and are integrated in pest management of arthropod as biopesticides. EPNs are environmentally safe and relatively benign to mammals and other nontarget organisms, and therefore considered sustainable biopesticides. EPNs are non-segmented roundworms that infect insects including the larval, pupal and adult forms of various insect orders such as Coleoptera, Diptera, Hemiptera, Lepidoptera, Orthoptera, etc. Entomopathogenic nematodes kill insects with the aid of symbiotic bacteria that are carried in the nematode intestine and released upon host infection. The infective juveniles (IJs) of nematodes penetrate the host insect via spiracles, mouth, anus, or in some species through intersegmental membranes of the cuticle, and into the hemocoel. The bacteria multiply in the insect hemolymph, and infected host usually dies within 24 to 48 hours. After which, the nematodes continue to feed on the host tissue and the proliferated bacteria, mature, and reproduce. One or more generations may occur within the host cadaver, and a large number of IJs are eventually released into the environment to infect other hosts and continue their life cycle.

Entomopathogenic nematodes have been used to control a wide variety of economically important pests, such as disclosed in Shapiro-Ilan, D. I. et al., Advances in use of entomopathogenic nematodes in IPM, In: Integrated management of insect pests: Current and future developments, M. Kogan and E. A. Heinrichs (Eds.), Burleigh Dodds Science Publishing, Cambridge, UK, Pp. 649-678, 2020, the contents of which are incorporated herein by reference. However, commercialization and large-scale use of EPNs are limited by their short shelf-life in formulations and in storage, leading to poor quality and reduced efficacy against insects in the field.

The inventors postulated that the encapsulation of entomopathogenic organisms such as EPNs by means of Pickering emulsion, may have a significant potential for the development of new biopesticide formulations.

### SUMMARY OF THE INVENTION

In one aspect, there is provided a composition comprising an entomopathogenic organism coated by a plurality of nanoparticles, wherein the plurality of nanoparticles comprises a UV-shielding nanoparticles, wherein the composition is an aqueous dispersion of the entomopathogenic organism.

In one embodiment, UV-shielding nanoparticles are assembled within a core-shell particle.

In one embodiment, the core-shell particle comprises a liquid core comprising an oil, and wherein the liquid core is enclosed by a shell comprising the plurality of nanoparticles.

In one embodiment, the core-shell particle is characterized by an average particle size between 1 and 50 um.

In one embodiment, (i) a weight ratio between the plurality of nanoparticles and the oil within the core-shell particle or within the composition is between 1:10 and 1:100; (ii) a w/w concentration of the plurality of nanoparticles within the composition is between 0.1 and 10%.

In one embodiment, the UV-shielding nanoparticles are chemically modified metal oxide particles.

In one embodiment, the metal oxide particles comprise a metal oxide selected from SiO₂, TiO₂ or both; and wherein the chemically modified comprises a functional moiety covalently bound to the metal oxide particles.

In one embodiment, the metal oxide comprises TiO₂ and the functional moiety comprises any one of: (i) aminoalkyl group, amino group, hydroxyalkyl group, thioalkyl group, aminoalkyl silane group, hydroxyalkyl silane group, thioalkyl silane group, or any combination thereof; (ii) a UV-absorbing group, or both (i) and (ii).

In one embodiment, the metal oxide comprises SiO₂ and the functional moiety comprises a UV-absorbing group.

In one embodiment, the entomopathogenic organism comprises a nematode.

In one embodiment, the nematode is an entomopathogenic Infective juvenile (IJ) nematode.

In one embodiment, the oil is a liquid at a temperature between 1° and 60° C.

In one embodiment, the oil is characterized by viscosity at 25° C. between 1 and 100 cP.

In one embodiment, the oil is any one of: (i) substantially non-toxic to the entomopathogenic organism; (ii) substantially devoid of phytotoxicity.

In one embodiment, the oil comprises a mineral oil, a C10-C30 aliphatic hydrocarbon, a fatty acid, a monoglyceride, a diglyceride, a triglyceride, a plant oil, wax, an essential oil, an aromatic oil, or any combination thereof.

In one embodiment, the composition further comprises a gelation agent.

In one embodiment, gelation agent is a polymeric gelation agent comprising a polyacrylic acid, polyvinyl alcohol, polyethylene oxide, polyethylene glycol, poly(2-hydroxyethyl methacrylate), polyacrylamide, or a polysaccharide, including any salt and any combination thereof.

In one embodiment, a w/w concentration of the gelation agent within the composition is between 0.1 and 10%.

In another aspect, there is provided a pesticide composition comprising the composition of the invention; wherein the pesticide composition comprises a pesticidal effective amount of the entomopathogenic organism.

In one embodiment, pesticide composition is formulated for application to a plant, a plant part and/or to an area under cultivation, wherein application is by spraying or coating.

In one embodiment, the pesticidal effective amount comprises a concentration of the entomopathogenic organism being at least 10 units/ml.

In another aspect, there is provided an article comprising a substrate in contact with a coating comprising the pesticide composition of the invention.

In one embodiment, the coating is in a form of a coating layer.

In one embodiment, the substrate is selected from, a plant or a plant part, a polymeric substrate, a glass substrate, a metallic substrate, a fiber, a paper substrate, a brick wall, a sponge, a textile, a woven fabric, a non-woven fabric, or wood or any combination thereof.

In one embodiment, the coating is a pesticide coating.

In one embodiment, the coating substantially retains its pesticide activity when exposed to outdoor conditions for a time period between 1 and 30 d.

In another aspect, there is provided a method for controlling a pest, comprising applying an effective amount of the pesticide composition of the invention to at least a portion of a plant, or to an area under cultivation infested with the pest, thereby controlling or reducing growth of the pest.

In one embodiment, the pesticide composition is characterized by adhesiveness to at least a part of the plant.

In one embodiment, applying comprises any of immersion, soaking, coating, irrigating, dipping, spraying, fogging, scattering, painting, injecting, or any combination thereof.

In one embodiment, the pest comprises an arthropod.

In one embodiment, the effective amount is between 1 and 1000 L/ha.

In one embodiment, the arthropod is a plant pest.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 represents a schematic illustration representing schematic illustration of APTES salinization onto TiO₂ surface.

FIGS. 2A-2D are micrographs representing confocal microscopy images of the droplets in Pickering emulsion with 2% of TiO₂—NH₂ at 50:50 oil/water ratio, (2A) droplets with TiO₂—NH₂ without fluorescence, (2B) droplets with TiO₂—NH₂ dyed in carboxyfluoresceine. Cryo-SEM micrographs of Pickering emulsion with 1% TiO₂—NH₂ NPs at 40:60 oil:water volume fractions ratio, (2C) droplets with 1% TiO₂—NH₂ NPs at 40:60 oil:water volume fractions ratios, (2D) droplets with 1% TiO₂—NH₂ NPs at 40:60 oil:water volume fraction ratios.

FIG. 3A-3F are images representing TiO₂—NH₂ Pickering emulsion oil/water ratio with NPs content of wt %: (3A) 40:60, 0.4 wt %. (3B) 50:50, 0.4 wt %. (3C) 40:60, 1 wt %. (3D) 50:50, 1 wt %. (3E) 40:60, 2 wt %. (3F) 50:50, 2 wt %.

FIG. 4 is a graph presenting the instability index of Pickering emulsions as a function of TiO2-NH2 content (wt %) and oil percentages in the emulsion (vol %). *instability indices of both 40:60 and 50:50 (2%) is 0.001.

FIGS. 5A-5C are micrographs representing confocal microscopy images of the liquid phase of nematodes incorporation in TiO₂—NH₂ Pickering emulsion oil:water volume fractions, (5A) 40:60, 0.4%. (5B) 40:60, 1%. (5C) 40:60, 2%. Scale bar is 100 μm.

FIGS. 6A-6D are micrographs representing confocal microscopy images of the dry nematode. Nematode in Pickering emulsion using 1% TiO₂—NH₂-carboxyfluoresceine at oil/water ratio 40:60 with (6B) and without (6A) green laser excitation at 480 nm. Blue arrow marks the dried oil droplets. (6C) 3D images of nematode in Pickering emulsion using 1% TiO₂—NH₂-carboxyfluoresceine at 40:60 oil:water volume fractions with (6D) and without (c) green laser excitation at 480 nm. The red arrow marks TiO₂—NH₂.

FIGS. 7A-7D are micrographs representing SEM images of nematodes in Pickering emulsion with 1% TiO2-NH2 NPs at 40:60 oil:water volume fractions. SEM micrographs of nematodes with (7B,7D) and without (7A,7C) without Pickering emulsion. The arrows mark the TiO2-APTES nanoparticles.

FIG. 8 is a graph presenting survival rates of Steinernema carpocapsae nematodes during 150 days in water (blue), 2% TiO₂—NH₂ emulsions at 40:60 (red) and 50:50 (green) volume fractions of oil:water.

FIG. 9 is a graph presenting a yield of Steinernema carpocapsae IJ from infected Galleria mellonella cadavers collected for 15 days from emergence. Error bars represent standard deviation. Infective juvenile (IJ) yield were subjected to one-way ANOVA. No significance were observed within the compared parameters (P>0.05).

FIG. 10 is a bar graph presenting mortality of Steinernema carpocapsae infective juveniles in various formulations (titania (TiO₂), 1% and 2% Barricade (barri), and water for aqueous IJs) after exposure to ultraviolet (UV, 254 nm) light for 10 or 20 min or no UV treatment (mean±sem). The same capital and lower case letters indicate no significant difference between times of UV exposure for each formulation and between formulations for each UV exposure time, respectively (Tukey-Kramer test, α=0.05).

FIGS. 11A-11B are bar graphs presenting percentage mortality (11A) and infection (11B) in Galleria mellonella larvae caused by Steinernema carpocapsae infective juveniles in various formulations (titania-TiO₂, 1% and 2% Barricade (barri), and water for aqueous IJs) after exposure to ultraviolet (UV, 254 nm) light for 10 or 20 min, or no-UV treatment in addition to control (without nematodes) for each formulation (mean±sem). The same capital and lower case letters indicate no significant difference between times of UV exposure for each formulation and between formulations for each UV exposure time, respectively (Tukey-Kramer test, α=0.05).

FIG. 12 is a bar graph presenting the number of nematodes (mean±sem) recovered from Galleria mellonella cadaver exposed to Steinernema carpocapsae infective juveniles in the titania (TiO₂)-based formulation or water control after treatment with ultraviolet (UV, 254 nm) light for 10 or 20 min or no-UV treatment. NS=no significant difference between water and TiO2 for no-UV; the same letters indicate no significant difference between times of UV exposure.

FIGS. 13A-13B are bar graphs presenting the comparison of (13A) survival (%) and (13B) the number of infective juveniles per leaf surface area of Steinernema carpocapsae and Steinernema feltiae over time. The time points represented here are 0 h (immediate after application), 1, 2, 3, and 4 h. Survival (%) were arcsine square-root transformed and subjected to ANOVA. When ANOVA F was significant (p<0.05), means were compared using the student's t-test. Different letters above bars represent significant differences.

FIGS. 14A-14C are bar graphs presenting the comparison of (14A) survival (%) (14B) the number of survived Infective Juveniles per leaf surface area (14C) insect mortality (%) on cotton leaves applied with Steinernema carpocapsae in water and formulation (TPE and SPEG) over time. The time points represented are 0 hrs (immediate after application), 24, 48, 72, and 96 hrs post application. Insect mortality represents the mean uncorrected mortality of 4^{th} instar Spodoptera littoralis 48 hours after incubation at 23° C. Bars indicate standard error. Survival (%) was arcsine square-root transformed and subjected to ANOVA. When ANOVA F was significant (p<0.05), means were compared using Student's t-test. Different alphabets represent significant difference. Insect mortality (%) was subjected to multiple comparisons by Student's t-test (NS/* indicates overall significance at a given time point P=0.05). At the same time, means without a common letter differ (Bonferroni test, P≤0.05).

### DETAILED DESCRIPTION OF THE INVENTION

According to some embodiments, the present invention provides a composition comprising an entomopathogenic organism coated by a plurality of UV-shielding nanoparticles. In some embodiments, the UV-shielding nanoparticles are synthetic particles. In some embodiments, the nanoparticles are synthetic particles. In some embodiments, the composition is a liquid composition. In some embodiments, the composition is flowable. In some embodiments, the composition is an aqueous dispersion. In some embodiments, the composition is a liquid at a temperature between 0 and 90° C. In some embodiments, the composition is in a form of an oil-in-water emulsion (e.g., oil-in-water Pickering emulsion). The nanoparticles according to the present invention are assembled within core-shell particles comprising a shell composed of hydrophobic nanoparticles, wherein the shell encloses a liquid core comprising an oil. In some embodiments, the composition is substantially non-toxic (e.g., non-phytotoxic). In some embodiments, the entomopathogenic organism is viable within the composition of the invention. In some embodiments, the core-shell particles and/or the entomopathogenic organism coated therewith are dispersed with an aqueous solvent. In some embodiments, the composition is an aqueous dispersion comprising a plurality of coated entomopathogenic organisms dispersed therewithin.

In some embodiments, the composition is a dry solid composition characterized by a water content of less than 5%, less than 1% or less. In some embodiments, the dry composition comprises the entomopathogenic organism coated by or in contact with a plurality of core-shell particles, as described herein.

According to some embodiments, the present invention provides a an entomopathogenic organism coated by a plurality of UV-shielding nanoparticles. In some embodiments, the entomopathogenic organism is incorporated within a liquid composition. In some embodiments, the liquid composition is a dispersion. In some embodiments, the entomopathogenic organism is coated by a composition in a form of a water-in-oil emulsion (e.g., water-in-oil Pickering emulsion).

Alternatively, the composition comprises core-shell particles and an oil, wherein the cores-hell particles comprise a shell enclosing an aqueous core. The nanoparticles according to the present invention are hydrophobic nanoparticles and are assembled within the shell of core-shell particles In some embodiments, the core-shell particles and/or the entomopathogenic organism coated therewith are dispersed with an oil solution. In some embodiments, the composition is an oil dispersion comprising a plurality of coated entomopathogenic organisms dispersed therewithin.

In some embodiments, upon application on a plant, the water-in-oil emulsion substantially retains its water content for about 24 hours.

According to one aspect of the present invention, there is provided a composition (e.g. a dispersion, or emulsion) comprising an entomopathogenic organism coated by or in contact with a plurality of nanoparticles, wherein the plurality of nanoparticles comprises hydrophobic nanoparticles; wherein the plurality of nanoparticles is assembled within a core-shell particle comprising a liquid aqueous core and the plurality of nanoparticles arranged in a shell stabilizing the liquid core. Optionally, the entomopathogenic organism is dispersed within an oil-based major phase. In some embodiments, the composition is liquid or a fluid (e.g., a free-flowable liquid composition). In some embodiments, the composition comprises a gelation agent. In some embodiments, the composition is formulated for application via for example spraying, fogging, brushing, etc. In some embodiments, the composition and/or the entire constituents thereof is/are non-phytotoxic.

In some embodiments, the shell is a single-layer shell. In some embodiments, the particles are in the interface between the aqueous phase and the oil phase. In some embodiments, the entomopathogenic organism is configured to infest and/or kill an insect. In some embodiments, the entomopathogenic organism is viable within the composition, so that upon exposure thereof to a plant and/or habitat the entomopathogenic organism is characterized by an anti-pathogenic activity.

According to one aspect of the present invention, there is provided an aqueous dispersion comprising an entomopathogenic organism coated by or in contact with a plurality of nanoparticles, wherein the plurality of nanoparticles comprises UV-shielding nanoparticles; wherein the plurality of nanoparticles is assembled within a core-shell particle comprising a liquid oil as a core and the plurality of nanoparticles arranged in a shell stabilizing the liquid core. In some embodiments, the composition is liquid or a fluid (e.g., a free-flowable liquid composition). In some embodiments, the composition is substantially devoid of a gel (e.g., hydrogel) or any non-Newtonian fluid. In some embodiments, the composition is formulated for application via for example spraying, fogging, brushing, etc. In some embodiments, the composition and/or the entire constituents thereof is/are non-phytotoxic.

In some embodiments, the shell is a single layer shell. In some embodiments, the particles are in the interface between the core comprising an oil (e.g., a minor phase) and the aqueous solvent (e.g., major phase). In some embodiments, the entomopathogenic organism is configured to infest and/or kill an insect. In some embodiments, the entomopathogenic organism is viable.

The invention in some embodiments thereof is based on a surprising finding that Pickering emulsions (i.e., oil-in-water based and oil-in-water based emulsions) comprising between about 1 and about 5% w/w of surface modified metal oxide nanoparticles (e.g. titania, or silica-based particles), are superior for coating of entomopathogenic nematodes, thus maintaining viability of the nematodes within the composition of the invention and under ambient conditions (i.e., upon application of the composition to a plant and/or an area under cultivation). Furthermore, the compositions of the invention comprising coated entomopathogenic nematodes (EPN), were characterized by an enhanced or prolonged viability and/or pesticidal activity under open field conditions, compared to non-encapsulated entomopathogenic nematodes (e.g., a composition solely composed of the EPN and an aqueous solvent).

### Oil-In-Water-Composition

In one aspect of the present invention, there is provided a composition (e.g. a liquid composition) comprising a plurality of particles, wherein at least 50%, at least 60%, at least 70%, at least 80%, at least 90%, at least 95%, at least 97%, at least 99% of the particles within the composition coat or cover at least one entomopathogenic organism. In some embodiments, the particles are micron-sized particles in the form of droplets stabilized by a shell. In some embodiments, the particles are in the form of core-shell particles (e.g., each particle comprises a shell and a core). In some embodiments, the composition is in a form of an emulsion or dispersion. In some embodiments, the particles are in the form of a colloidosome. In some embodiments, the liquid composition is an O/W Pickering emulsion. In some embodiments, the liquid composition is a flowable composition (or a fluid) at a temperature between 0 and 90° C. In some embodiments, the liquid composition is a liquid at a temperature between 0 and 90° C.

As used herein, the term “Pickering emulsion” refers to an emulsion that utilizes solid particles as a stabilizer to stabilize droplets of a substance, in a dispersed phase in the form of droplets dispersed throughout a continuous phase.

As used herein, the term “emulsion” refers to a combination of at least two fluids, where one of the fluids is present in the form of droplets in the other fluid. The term “emulsion” includes microemulsions.

As used herein, the term “fluid” refers to a substance that tends to flow and to conform to the outline of its container, i.e., a liquid, a gas, a viscoelastic fluid, etc. Typically, fluids are materials that are unable to withstand a static shear stress, and when a shear stress is applied, the fluid experiences a continuing and permanent distortion. The fluid may have any suitable viscosity that permits flow. In some embodiments, fluid is characterized by a viscosity sufficient for application thereof (e.g., to a plant or a plant part and/or to an area under cultivation), such as by spraying or fumigation. If two or more fluids are present, each fluid may be independently selected among essentially any fluids (liquids, gases, and the like) by those of ordinary skill in the art, by considering the relationship between the fluids. In some cases, the droplets may be contained within a carrier fluid, e.g., a liquid.

According to one aspect of the present invention, the composition of the invention is a fluid (or a flowable composition) comprising an aqueous solvent and core-shell particles dispersed within the aqueous solvent, wherein each of the core-shell particles comprises a liquid core enclosed by a shell comprising nanoparticles; the liquid core comprises an oil; the nanoparticles are chemically surface modified metal oxide nanoparticles; a w/w ratio between the aqueous solvent and the oil within the composition is between 70:30 and 40:60, or between about 70:30 and about 50:50 wherein a w/w concentration of the nanoparticles within the composition is between 0.1 and 10%; and the nanoparticles are in contact with, coating and/or encapsulating an entomopathogenic organism. In some embodiments, each entomopathogenic organism within the composition of the invention is encapsulated or coated by the core-shell particles. In some embodiments, at least 50%, at least 70%, at least 80%, at least 90%, at least 95%, at least 99% of the entire surface of the entomopathogenic organism is enclosed, encapsulated and/or in contact with the core-shell particles.

In some embodiments, the composition of the invention comprises an aqueous solvent (also referred to herein as “major phase”) and a plurality of the core-shell particles of the invention dispersed therewithin.

In some embodiments, the aqueous solvent is an agriculturally acceptable carrier.

In some embodiments, the oil is water immiscible and is substantially devoid of entomopathogenic toxicity. In some embodiments, the oil is characterized by water solubility of less than 1 g/100 L, less than 0.1 g/100 L, less than 0.01 g/100 L, less than 0.001 g/100 L, including any range therebetween.

In some embodiments, the oil is characterized by water solubility of between 0.0001 and 0.1 g/100 L, between 0.0001 and 0.001 g/100 L, between 0.001 and 0.005 g/100 L, between 0.005 and 0.01 g/100 L, between 0.01 and 0.05 g/100 L, between 0.05 and 0.1 g/100 L, including any range therebetween.

In some embodiments, the oil is a hydrophobic solvent compatible with the entomopathogenic organism. In some embodiments, the term “compatible” as used herein, refers to the solvent which doesn't substantially affect viability of the entomopathogenic organism. In some embodiments, the term “compatible” as used herein, refers to the solvent which doesn't substantially affect viability of a plant. In some embodiments, the oil is referred to as compatible when it reduces viability of not more than 20%, not more than 15%, not more than 10%, not more than 5%, not more than 1% of the initial entomopathogenic organism population, wherein the viability reduction is upon exposure of entomopathogenic organism to the solvent for a time period of less than 20 min, less than 15 min, less than 10 min, less than 1 min including any range between. In some embodiments, the entomopathogenic organism is compatible with the oil when exposed thereto at the processing conditions disclosed herein. In some embodiments, the oil is referred to as compatible when it is substantially non-toxic to the entomopathogenic organism, and/or substantially non-toxic to a plant.

In some embodiments, the oil is characterized by a boiling point of at least 80° C., at least 90° C., at least 100° C., at least 120° C., at least 150° C., at least 170° C., at least 200° C., including any range between.

In some embodiments, the oil is characterized by viscosity at 25° C. of between 1 and 100 cP, between 1 and 5 cP, between 5 and 10 cP, between 10 and 15 cP, between 15 and 20 cP, between 20 and 100 cP, between 10 and 100 cP, between 10 and 50 cP, between 50 and 100 cP, between 15 and 30 cP, between 15 and 50 cP, between 20 and 50 cP, between 10 and 30 cP, between 10 and 40 cP, between 10 and 60 cP, between 10 and 70 cP, between 10 and 80 cP, including any range between.

In some embodiments, the oil comprises or is selected from a mineral oil, a C10-C30 aliphatic hydrocarbon, a fatty acid, a monoglyceride, a diglyceride, a triglyceride, a vegetable oil, a wax, an essential oil, an aromatic oil, or any combination thereof.

In embodiments, the oil is selected from the group consisting of mineral oil, essential oil, vegetable oil, organic oil, lipid, and any water-immiscible liquid which is compatible with the entomopathogenic organism.

As used herein, the term “mineral oil” refers to an oil obtained from a mineral source. In some embodiments, mineral oil refers to a liquid by-product of refining crude oil to make gasoline and other petroleum products. A mineral oil is any of various colorless, odorless, light mixtures of alkanes in the range of C-10 to C-40 or of C-15 to C-40. Mineral oil is available in light and heavy grades. In some embodiments mineral oil refers to a raw and/or purified distillate fraction obtained from a mineral source. In some embodiments, the mineral oil is chemically modified. Mineral oils are well known in the art and are used herein in the same manner as they are commonly used in the art. Such oils are readily available from commercial chemical suppliers throughout the world. Methods for preparation of mineral oils are well known in the art.

In some embodiments, the oil is or comprises a C10-40, C10-20, C10-30, C10-15, C15-30, C15-40, C15-20, C20-30, C20-40 hydrocarbon chain, including any range between.

Non-limiting examples of a suitable oil according to the present invention include mineral oil, paraffinic oil (based on n-alkanes), naphthenic oil (based on cycloalkanes), hydrocarbon oil (based on hydrocarbons), a fatty acid (including a short-chain fatty acid and/or a long chain fatty acid) and/or any ester thereof, a vegetable oil (oil comprising fatty acids and/or esters thereof extracted from seeds, or other plant parts), wax, essential oil (based on extracts from plants), and aromatic oil (based on aromatic hydrocarbons and distinct from essential oils). Such oils are well known in the art.

In some embodiments, the oil is or comprises a single oil species. In some embodiments, the oil is a fluid consisting essentially of a mineral oil, a C10-C30 aliphatic hydrocarbon, a fatty acid, a monoglyceride, a diglyceride, a triglyceride, a plant oil, wax, an essential oil, an aromatic oil, or any combination thereof. In some embodiments, the oil is substantially devoid of an additional liquid.

In some embodiments, the core-shell particle of the invention comprises an oil core and an amphiphilic shell. In some embodiments, the core-shell particle is in a form of a colloidosome.

In some embodiments, the core-shell particle has a substantially spherical geometry or shape. In some embodiments, a plurality of core-shell particles is devoid of any characteristic geometry or shape. In some embodiments, the core-shell particle has a spherical shape, a quasi-spherical shape, a quasi-elliptical sphere, a concave shape, an irregular shape, or any combination thereof. One skilled in the art will appreciate that the exact shape of each of the plurality of core-shell particles may differ from one particle to another. Moreover, the exact shape of the core-shell particle may be derived from any of the geometric forms listed above, so that the shape of the particle does not perfectly fit to a specific geometrical form. One skilled in the art will appreciate that the exact shape of the core-shell particle may have substantial deviations (such as at least 5%, at least 10%, at least 20% deviation) from a specific geometrical shape (e.g., a sphere or an ellipse).

In some embodiments, the average particle size of the core-shell particles is between 0.5 μm and 100 μm, 1 μm to 100 μm, 1 μm to 50 μm, 10 μm to 50 μm, 1 μm to 10 μm, 10 μm to 50 μm, 10 μm to 20 μm, 20 μm to 50 μm, 20 μm to 30 μm, 30 μm to 50 μm, 50 μm to 80 μm, 1 μm to 20 μm, 1 μm to 30 μm, 5 μm to 30 μm, 10 μm to 30 μm, 10 μm to 50 μm, 1 μm to 40 μm, 1 μm to 5 μm, 1 μm to 8 μm, 5 μm to 10 μm, 5 μm to 50 μm, 5 μm to 20 μm, 5 μm to 30 μm, including any range or value therebetween.

In some embodiments, the size of the core-shell particle described herein represents an average size (e.g., arithmetic mean) of the plurality of particles within the composition of the invention.

In some embodiments, the average particle size refers to the size of at least 50%, 60%, 70%, 80%, 90%, 95% or 99% of the particles including any range between. In some embodiments, the average particle size ranges from: 5 μm to 50 μm, 1 μm to 50 μm, 5 μm to 30 μm, including any range therebetween. In some embodiments, the average particle size of the core-shell particles described herein, is a wet diameter (i.e., a diameter of particles within a liquid composition, as measured based on common particle size measurement techniques, such as microscopic examination, DLS or other methods known in the art). In some embodiments, a plurality of the core-shell particles has a uniform size. By “uniform” or “homogenous” it is meant to refer to size distribution that varies within a range of less than e.g., ±60%, ±50%, ±40%, ±30%, ±20%, or ±10%, including any value therebetween.

In some embodiments, the core-shell particle is in a form of a droplet.

As used herein, the term “droplet” refers to an isolated portion of a first fluid that is surrounded by a second fluid. It is to be noted that a droplet is not necessarily spherical; but may assume other shapes as well, for example, depending on the external environment. The fluidic droplets may have any shape and/or size. Typically, monodisperse droplets are of substantially the same size. In some embodiments, the average particle size of the droplet refers to the cross-section dimension (e.g., diameter) of the droplet. In some embodiments, the cross-section dimension refers to the largest distance between two points at the outer portion of the particle's shell. The average particle size of a single droplet, in a non-spherical droplet, is the diameter of a perfect sphere having the same volume as the non-spherical droplet.

In some embodiments, the core-shell particle comprises between 0.5% and 20%, between 0.5% and 1%, between 1% and 10%, between 1% and 5%, between 2% and 3%, between 3% and 5%, between 5% and 10%, between 10% and 20% (w/w) of the nanoparticles (i.e. hydrophilic nanoparticles) by weight of the core-shell particle, including any range therebetween.

In some embodiments, a weight ratio between the plurality of nanoparticles and the oil within the core-shell particle or within the composition of the invention is between 1:10 and 1:100, between 1:10 and 1:80, between 1:10 and 1:50, between 1:30 and 1:50, between 1:20 and 1:50, between 1:30 and 1:100, between 1:30 and 1:80, between 1:50 and 1:100, including any range between.

In some embodiments, the shell is in a form of a layer. In some embodiments, the shell is in a form of a uniform layer. In some embodiments, the shell is in a form of a homogenous layer. In some embodiments, the nanoparticles are homogenously distributed within the entire volume of the shell. In some embodiments, the nanoparticles are homogenously distributed on top of the liquid core. In some embodiments, the nanoparticles are homogenously distributed on the surface of the liquid core (e.g., in the interphase between the major phase and the minor phase).

In some embodiments, the shell comprises an inner portion facing the core (e.g., particle's core) and an outer portion facing the aqueous solvent. In some embodiments, the shell is located in the interphase. In some embodiments, the composition is an o/w emulsion, wherein the minor oil phase forms a core, and a shell of the core-shell particle of the invention is located in the interphase.

In some embodiments, the shell stabilizes the core. In some embodiments, the shell encapsulates the core.

In some embodiments, the shell has a thickness in the range of 5 nm to 50 nm, 15 nm to 50 nm, 30 nm to 50 nm, 1 nm to 50 nm, 2 nm to 50 nm, 5 μm to 10 nm, 10 nm to 50 nm, 5 nm to 30 nm, 15 nm to 30 nm, 1 nm to 20 nm, 2 nm to 20 nm, 5 nm to 20 nm, or 10 nm to 20 nm, 20 nm to 30 nm, 30 nm to 40 nm, 40 nm to 80 nm, 80 nm to 100 nm, 100 nm to 200 nm, 200 nm to 300 nm, 300 nm to 500 nm, including any range therebetween. In some embodiments, the shell thickness is quantified using scanning electron microscopy (SEM).

In some embodiments, the nanoparticle comprises UV-shielding nanoparticle. In some embodiments, the nanoparticle comprises a UV-shielding metal/metalloid oxide nanoparticle. In some embodiments, the nanoparticles comprise a metal/metalloid oxide as a core and UV-shielding surface groups covalently bound thereto. In some embodiments, the metal/metalloid oxide comprises a divalent metal oxide or a tetra-valent metal oxide selected from silicon oxide, titanium dioxide, zirconia, or any combination thereof.

In some embodiments, the term “UV-shielding nanoparticle” refers to a particle configured to absorb, reflect or dissipate the incoming UV radiation. In some embodiments, the core of the UV-shielding nanoparticle (e.g., a tetravalent metal oxide) is UV-shielding, i.e., is capable of absorbing, reflecting, or dissipating (e.g., via scattering) the incoming UV radiation. Exemplary UV-shielding tetravalent metal oxide particles are titanium dioxide nanoparticles.

In some embodiments, each nanoparticle is a chemically modified metal/metalloid oxide nanoparticle. In some embodiments, chemically modified metal/metalloid oxide nanoparticle comprises a functional moiety covalently bound to the metal/metalloid oxide nanoparticle. In some embodiments, chemically modified metal oxide nanoparticle is a hydrophilic particle. In some embodiments, the hydrophilic particle comprises a hydrophilic functional moiety.

In some embodiments, each nanoparticle is a chemically modified titanium dioxide (e.g., comprising Ti(IV) and optionally further comprises Ti(III) element) particle comprising a functional moiety covalently bound to the nanoparticle. In some embodiments, the functional moiety (i.e. the hydrophilic functional moiety) comprises aminoalkyl group, amino group, hydroxy, carboxy, thio, hydroxyalkyl group, thioalkyl group, aminoalkyl silane group, hydroxyalkyl silane group, thioalkyl silane group, or any combination thereof.

In some embodiments, the functional moiety is represented by Formula:

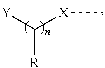

wherein the dashed bond represents an attachment point to the particle (e.g. to the oxygen atom of the particle); n is a integer ranging from 1 to 30; Y is H or comprises a heteroatom; X is an optionally substituted C1-C10 alkyl, Si(R₁)₂ or is absent; R is H or a substituent; and each R1 independently H, a bond, —O—, a substituent, an optionally substituted C₁-C₆ alkyl, —O(C₁-C₆ alkyl), —OH, or a combination thereof.

In some embodiments, each substituent is independently selected from —NO₂, —CN, —OH, —CONH₂, —CONR′₂, —CNNR′₂, —CSNR′₂, —CONH—OH, —CONH—NH₂, —NHCOR′, —NHCSR′, —NHCNR′, —NC(═O)R′, —NC(═O)OR′, —NC(═O)NR′, —NC(═S)OR′, —NC(═S)NR′, —SO₂R′, —SOR′, —SR′, —SO₂OR′, —SO₂N(R′)₂, —NHNR′₂, —NNR′, carbonyl, C₁-C₁₀ haloalkyl, optionally substituted C₁-C₁₀ alkyl, —NH₂, —N(R′)₂, —NH(C₁-C₁₀ alkyl), —N(C₁-C₁₀ alkyl)₂, C₁-C₁₀ haloalkoxy, hydroxy(C₁-C₁₀ alkyl), hydroxy(C₁-C₁₀ alkoxy), alkoxy(C₁-C₁₀ alkyl), alkoxy(C₁-C₁₀ alkoxy), amino(C₁-C₁₀ alkyl), —CONH(C₁-C₁₀ alkyl), —CON(C₁-C₁₀ alkyl)₂, —CO₂H, —CO₂R′, —OCOR′, —C(═O)R′, —OC(═O)OR′, —OC(═O)NR′, —OC(═S)OR′, —OC(═S)NR′, a heteroatom, cycloalkyl, heterocyclyl aryl, heteroaryl, (C₁-C₁₀ alkyl)alkyl-cycloalkyl, (C₁-C₁₀ alkyl)alkyl-aryl, (C₁-C₁₀ alkyl)alkyl-heteroaryl, or any combination thereof, and wherein each of cycloalkyl, heterocyclyl aryl, heteroaryl is substituted or non-substituted; and each R′ is independently H, or comprises an optionally substituted C₁-C₁₀ alkyl, an C₁-C₁₀ alkyl-aryl, an C₁-C₁₀ alkyl-cycloalkyl, optionally substituted C₃-C₁₀ cycloalkyl, optionally substituted C₃-C₁₀ heterocyclyl, optionally substituted heteroaryl, optionally substituted aryl or a combination thereof. In some embodiments, the heteroatom is or comprises S, O, SR′, OR′, or N(R′)₂.

In some embodiments, Y is N(R′)₂, and X is Si(R₁)₂.

In some embodiments, the functional moiety is represented by Formula:

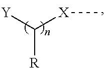

wherein the dashed bond represents an attachment point to the particle (e.g. to the oxygen atom of the particle); n is a integer ranging from 1 to 30, 1-10, 1 to 20, 3 to 5, 3 to 30, 3 to 20, 3 to 10, including any range between; R is as described herein; Y is N(R′)₂; and X is Si(R₁)₂, wherein each R1 independently —O(C₁-C₆ alkyl), —O—, —OH, H, an optionally substituted C₁-C₆ alkyl, or a combination thereof.

In some embodiments, the functional moiety and/or the nanoparticle of the invention is positively charged (e.g., bearing an intrinsic positive charge or undergoing protonation in an aqueous solvent such as at a pH between 0 and 9). In some embodiments, the nanoparticles of the invention are characterized by a positive zeta potential.

In some embodiments, the functional moiety comprises

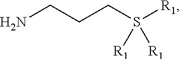

wherein each R1 is as described herein, and wherein at least one R1 an attachment point to the particle (e.g., to the oxygen atom of the particle).

In some embodiments, the functional moiety is substantially devoid of a halo group (such as fluoro and/or chloro moieties). In some embodiments, the functional moiety is substantially devoid of a halo-alkyl moiety. In some embodiments, functional moiety is substantially devoid of a halo-alkyl silane moiety. In some embodiments, the functional moiety is devoid of fluorine atom(s).

In some embodiments, the nanoparticles characterized by a contact angle below 90°, 85°, 80°, 75°, are referred to as hydrophilic nanoparticles, including any range or value in between.

In some embodiments, the nanoparticle comprises a metal oxide particle (e.g., UV-shielding or non UV-shielding particle) and a functional moiety bound thereto, wherein the functional moiety comprises a UV-shielding group. As used herein, the term “UV shielding” refers to compounds or chemical groups that absorb, reflect and/or dissipate ultraviolet light. UV absorbing compounds or chemical groups, comprise functional groups (chromophores) that contain valence electrons of low excitation energy. In some embodiments, the UV-absorbing group comprises a plurality of aromatic (and/or heteroaromatic) rings (fused, bi-cyclic, or polycyclic rings).

In some embodiments, the UV-shielding group or UV-shielding nanoparticle is characterized by at least one of: (i) UV absorbance, (ii) UV reflection, and (iii) UV scattering between 60% and 100%, between 65% and 100%, between 70% and 100%, between 80% and 100%, between 90% and 100%, between 95% and 100%, between 60% and 99%, between 65% and 99%, between 70% and 99%, between 80% and 99%, between 90% and 99%, between 95% and 99%, between 60% and 98%, between 65% and 98%, between 70% and 98%, between 80% and 98%, between 90% and 98%, between 95% and 98%, between 60% and 95%, between 65% and 95%, between 70% and 95%, between 80% and 95%, between 90% and 95%, between 60% and 80%, between 65% and 80%, or between 70% and 80%, including any range therebetween, relative to the incoming UV light intensity. In some embodiments, UV absorbance is measured according to ASTM D1003. As used herein, the term “UV absorbance”, refers to the percentage of the incoming UV light intensity absorbed by the UV shielding group and/or UV-shielding nanoparticle.

The term “silica” as used here refers to a structure containing at least the following the elements: silicon and oxygen. Silica may have the fundamental formula of SiO₂ or it may have another structure including SiₓO_{y} (where x and y can each independently be about 1 to 10).

In some embodiments, the metal oxide comprises nano clay, SiO₂, TiO₂, Al₂O₃, Fe₂O₃, ZnO, and ZrO or any combination thereof. In some embodiments, the nanoparticles are substantially non-porous particles. In some embodiments, the nanoparticles are substantially porous particles (e.g., mesoporous particles).

In some embodiments, the nanoparticles are surface modified metal oxide nanoparticles comprising (i) TiO₂-based and/or (ii) SiO₂ particles modified by the functional moiety, as described hereinabove.

In some embodiments, the oil constitutes between 50% and 90%, between 50% and 70%, between 70% and 90%, between 70% and 99%, between 80% and 99%, between 90% and 99% by weight of the core of the core shell particle of the invention (e.g., droplet), including any range therebetween. In some embodiments, the terms “core shell particle” and “particle” are used herein interchangeably.

In some embodiments, the nanoparticles are characterized by an average (e.g., arithmetic mean) particle size of 1 nm to 900 nm. In some embodiments, the average particle size of the nanoparticles is between 2 nm to 600 nm, 2 nm to 550 nm, 2 nm to 520 nm, 2 nm to 500 nm, 2 nm to 480 nm, 2 nm to 450 nm, 2 nm to 400 nm, 2 nm to 350 nm, 2 nm to 300 nm, 2 nm to 250 nm, 2 nm to 200 nm, 2 nm to 150 nm, 2 nm to 100 nm, 5 nm to 600 nm, 10 nm to 600 nm, 15 nm to 600 nm, 20 nm to 600 nm, 40 nm to 600 nm, 50 nm to 600 nm, 100 nm to 600 nm, 5 nm to 500 nm, 10 nm to 500 nm, 15 nm to 500 nm, 20 nm to 500 nm, 40 nm to 600 nm, 50 nm to 500 nm, 100 nm to 500 nm, 5 nm to 400 nm, 10 nm to 400 nm, 15 nm to 400 nm, 20 nm to 400 nm, 40 nm to 400 nm, 50 nm to 400 nm, 100 nm to 400 nm, 5 nm to 50 nm, 5 nm to 40 nm, 2 nm to 50 nm, or 2 nm to 40 nm, including any range therebetween. In some embodiments, the size of at least 90% of the nanoparticles varies within a range of less than ±25%, ±20%, ±15%, ±19%, ±5%, including any value therebetween.

Herein throughout, the terms “nanoparticle”, “nano”, “nanosized”, and any grammatical derivative thereof, which are used herein interchangeably, describe a particle featuring a size of at least one dimension thereof (e.g., diameter, length) that ranges from about 1 nanometer to 100 nanometers. Herein throughout, “NP(s)” designates nanoparticle(s).

In some embodiments, the term “average” particle size refers to the physical diameter (also termed “dry diameter”) of the nanoparticles. In some embodiments, the dry diameter of the particles, according to some embodiments of the invention, may be evaluated using transmission electron microscopy (TEM) or scanning electron microscopy (SEM) imaging.

The nanoparticle(s) can be generally shaped as a sphere, incomplete sphere, particularly the size attached to the substrate, a rod, a cylinder, a ribbon, a sponge, and any other shape, or can be in a form of a cluster of any of these shapes, or a mixture of one or more shapes. In some embodiments, the hydrophobic particle has a spherical shape, a quasi-spherical shape, a quasi-elliptical sphere, an irregular shape, or any combination thereof.

In some embodiments, the nanoparticles are in the interface between a major phase and a minor phase. In some embodiments, the major phase is a continuous phase. In some embodiments, a minor phase is a dispersed phase. In some embodiments, the hydrophobic particles are in the interface of the major phase (e.g., the hydrophobic solvent described herein) and the core (e.g., aqueous core) of the core-shell particle described herein (e.g., colloidosome).

In some embodiments, a w/w concentration of the nanoparticles within the composition is between 0.5 and 10%, between 0.5 and 5%, between 0.8 and 10%, between 0.8 and 5%, between 0.9 and 10%, between 0.9 and 5%, between about 1 and 10%, between about 1 and 5%, between about 1 and 3%, between about 3 and 10%, between about 2 and 5%, between 5 and 10%, including any range between. In some embodiments, a w/w concentration of the nanoparticles affects the viscosity of the composition. In some embodiments, a w/w concentration of the nanoparticles predetermines the viscosity of the composition, and further predetermines the particle size of the core-shell particle of the invention.

In some embodiments, a w/w ratio between the aqueous solvent and the oil within the composition is between 70:30 and 40:60, between 70:30 and 45:65, between 70:30 and about 50:50, including any range between.

In some embodiments, the composition of the invention (o/w emulsion) comprising a w/w concentration of the nanoparticles between 0.5 and 10%, or between 1 and 3%, and a w/w ratio between the aqueous solvent and the oil as described herein is stable (e.g., devoid of phase separation, etc.) for a time period descried herein.

In some embodiments, the composition is a stable liquid composition. In some embodiments, the liquid composition is stable for at least 6 hours (h), at least 12 h, at least 24 h, at least 48 h, at least 72 h, at least 96 h, at least 10 days (d), at least one month (m), at least 6 m, at least 12 m % including any range therebetween.

As used herein the term “stable”, refers to the ability of the liquid composition to maintain substantially its intactness, such as being substantially devoid of aggregation, precipitation and/or phase separation. In some embodiments, a stable composition (e.g., the composition or the liquid composition of the invention) is substantially devoid of aggregates. In some embodiments, aggregates comprising a plurality of cores-shell particles adhered or bound to each other. In some embodiments, a stable composition is substantially devoid of free (e.g., non-encapsulated) entomopathogenic organisms. In some embodiments, the composition of the invention is referred to as stable when at least 70%, at least 80%, at least 85%, at least 90%, at least 95%, at least 97% including any range between, of the initial entomopathogenic organism loading remains encapsulated within the core-shell particle under suitable storage conditions and for a time period described herein. In some embodiments, the composition of the invention is referred to as stable, when at least 70%, at least 80%, at least 85%, at least 90%, at least 95%, at least 97% including any range between, of the initial entomopathogenic organism loading remains viable upon storage thereof under suitable storage conditions.

In some embodiments, the o/w emulsion further comprises a gelation agent. In some embodiments, the gelation agent is as described below (for w/o emulsion). In some embodiments, a w/w concentration of the gelation agent within the o/w emulsion is between 0.5 and 5%, between 0.5 and 10%, between 0.2 and 10%, between 0.8 and 5%, between 0.9 and 5%, between about 1 and 5%, between about 1 and 3%, between about 3 and 5%, between about 2 and 5%, between 0.5 and 4%, including any range between.

In some embodiments, the entomopathogenic organism is viable within the composition of the invention. In some embodiments, the entomopathogenic organism is viable within the composition of the invention, and/or the entomopathogenic organism is viable upon application of the composition of the invention to the plant/plant part; and/or to the area under cultivation. As used herein, the term “viable” encompasses being capable of: replicating a genome or DNA, infesting, or invading a host (e.g., an insect), reproduction, cell proliferation, RNA synthesis, protein translation, energy production process, secretion of bacteria, or any combination thereof.

In some embodiments, the composition comprises a single genus or distinct genera of the entomopathogenic organism. In some embodiments, the entomopathogenic organism is or comprises a biopesticide. In some embodiments, the entomopathogenic organism is characterized by a pesticidal (e.g., insecticidal) activity. In some embodiments, the entomopathogenic organism is capable of reducing or controlling growth (e.g., activity, propagation, etc.) of a pest. In some embodiments, the entomopathogenic organism is capable of reducing or controlling infestation of the plant and/or area under cultivation (e.g., infested by the pest). In some embodiments, the entomopathogenic organism is capable of preventing plant and/or soil infestation by the pest. In some embodiments, the entomopathogenic organism is characterized by toxicity to the pest. In some embodiments, the entomopathogenic organism is capable of initiating a systemic acquired resistance (SAR) in a plant.

The term “SAR” as used herein is well understood by a skilled artisan and refers inert alia to systemic reactions taking place after an infection of a plant or a plant part with a pathogen. SAR can be evaluated by well-known procedures, such as described in Ruisheng An et al., Biological Control, 93 (2016) 24-29.

In some embodiments, entomopathogenic organism is capable of reducing activity or loading of the pest, wherein the activity and/or loading refers to a plant (or a plant part) and/or area under cultivation (e.g., soil). In some embodiments, the plant part is selected from stem, a leave, inflorescence, a root, a fruit, a seed or any combination thereof.

In some embodiments, the entomopathogenic organism comprises a nematode. In some embodiments, the nematode is a nematode characterized by an insecticidal activity. In some embodiments, the nematode is an entomopathogenic nematode (EPN). In some embodiments, the nematode (e.g., EPN) is an Infective juvenile (IJ) nematode.

In some embodiments, the nematode (e.g., EPN) is selected from genera Heterorhabditis and Steinernema including any combination thereof. In some embodiments, the EPN is selected from Steinernema carpocapsae (Sc), Heterorhabditis bacteriophora (Hb), Heterorhabditis indica (Hi), Steinernema feltiae (Sf), Steinernema kraussei (Sk), Steinernema glaseri (Sg), Phasmarhabditis hermaphrodita (Ph), Phasmarhabditis neopapillosa (Pn), Phasmarhabditis californica (Pc), S. riobrave, S. scapterisci, and S. longicaudum, including any combination thereof. In some embodiments, the EPN comprises the Species S. carpocapsae (Sc). In some embodiments, the EPN comprises the Species H. bacteriophora (Hb). In some embodiments, the EPN comprises the Species Heterorhabditis indica (Hi). In some embodiments, the EPN comprises the Species Steinernema feltiae (Sf). In some embodiments, the EPN comprises the Species Steinernema kraussei (Sk). In some embodiments, the EPN comprises the Species Steinernema glaseri (Sg). In some embodiments, the EPN comprises the Species Phasmarhabditis hermaphrodita (Ph). In some embodiments, the EPN comprises the Species Phasmarhabditis neopapillosa (Pn). In some embodiments, the EPN comprises the Species Phasmarhabditis californica (Pc). In some embodiments, the EPN comprises the Species Heterorhabditis zealandica (Hz). In some embodiments, the EPN comprises the Species Heterorhabditis megidis (Hm).

In some embodiments, the EPN is in third-stage, infective juvenile (IJ) phase. In some embodiments, the EPN is in third-stage phase. In certain embodiments, the EPN is in infective juvenile (IJ) phase.

In some embodiments, 50-100%, 50-99%, 70-99%, 90-99%, 90-100%, of the nematodes in the composition are in IJ phase. In some embodiments, the entomopathogenic organism within the composition of the invention is essentially composed of IJ nematodes. In some embodiments, the entomopathogenic organism or the composition of the invention is active against plant pathogenic arthropods. In some embodiments, the composition of the invention is characterized by a specific insecticidal activity, wherein the specific insecticidal activity encompasses that the entomopathogenic organism and/or the composition comprising thereof is active exclusively against plant pathogenic insects.

In some embodiments, the pest is selected from an agricultural pathogen, a plant pathogen, veterinary pest, household pest, a soil pathogen or both. In some embodiments, the pathogen is selected from an aphid, an insect, or any combination thereof. In some embodiments, the pathogen (e.g., an agricultural pathogen, a plant pathogen and/or a soil pathogen) is selected from, but is not limited to: lepidoptera, a coleoptera, a hemiptera, a Diptera, an orthoptera, an acari, and a Gastropoda.

In certain embodiments, the pathogen is of the Order Lepidoptera. In certain embodiments, the pest is of the Suborder Aglossata. In certain embodiments, the pathogen is of the Suborder Glossata. In certain embodiments, the pathogen is of the Suborder Heterobathmiina. In certain embodiments, the pathogen is of the Suborder Zeugloptera.

In certain embodiments, the pathogen is of the Order Coleoptera. In certain embodiments the pathogen is of the Suborder Adephaga. In certain embodiments the pathogen is of the Suborder Archostemata. In certain embodiments the pathogen is of the Suborder Myxophaga. In certain embodiments the pathogen is of the Suborder Polyphaga. In certain embodiments the pest is of the Suborder Protocoleoptera.

In certain embodiments, the pathogen is of the Order Hemiptera. In certain embodiments the pathogen is of the Suborder Auchenorrhyncha. In certain embodiments the pathogen is of the Suborder Coleorrhyncha. In certain embodiments the pathogen is of the Suborder Heteroptera. In certain embodiments the pathogen is of the Suborder Sternorrhyncha.

In certain embodiments, the term “pathogen” and the term “pest” are used herein interchangeably. In certain embodiments, the pest is of the Order Diptera. In certain embodiments, the pest is of the Order Orthoptera. In certain embodiments the pest is of the Suborder Ensifera. In certain embodiments the pest is of the Suborder Caelifera. In certain embodiments, the pest is of the Subclass Acari. In certain embodiments, the pest is of the Suborder Acariformes. In certain embodiments, the pest is of the Suborder Parasitiformes.

In certain embodiments, the pest is of the Class Gastropoda. In certain embodiments, the pest is of the Family Arionidae. In certain embodiments, the pest is of the Family Milacidae. In certain embodiments, the pest is of the Family Agriolimacidae. In certain embodiments, the pest is of the Family Limacidae. In certain embodiments, the pest is of the Family Vaginulidae. In some embodiments, the pest is of the Family Thripidae, order Siphonaptera. In some embodiments, the pest a plant parasitic nematode. In some embodiments, the pest is of order Ixodida.

### Water-In-Oil

In another aspect of the present invention, the liquid composition in a form of a W/O emulsion (e.g. W/O Pickering emulsion).

According to one aspect of the present invention, there is provided a composition (e.g. a liquid composition or a flowable composition) comprising an oil, a gelation agent, and a plurality of nanoparticles, wherein the composition is in a form of core-shell particles dispersed within the oil, wherein each of the core-shell particles comprises a liquid core enclosed by a shell comprising the nanoparticles; the liquid core comprises an aqueous solvent; the nanoparticles are surface modified hydrophobic metal oxide nanoparticles; a w/w ratio between the oil solution and water within the composition is between 70:30 and 40:60, or between about 70:30 and about 50:50; wherein a w/w concentration of the nanoparticles within the composition is between 0.1 and 10%; and the nanoparticles are in contact with, coating and/or encapsulating an entomopathogenic organism. In some embodiments, each entomopathogenic organism within the composition of the invention is encapsulated or coated by the core-shell particles. In some embodiments, at least 50%, at least 70%, at least 80%, at least 90%, at least 95%, at least 99% of the entire surface of the entomopathogenic organism is enclosed, encapsulated and/or in contact with the core-shell particles.

In some embodiments, the core-shell particles comprise an aqueous core and an amphiphilic shell. In some embodiments, the core-shell particle is in a form of a colloidosome, as disclosed above.

In some embodiments, the shape of the core-shell particles (i.e. aqueous core particles) is as disclosed above. In some embodiments, the average particle size of the core-shell particles (i.e. aqueous core particles) is as disclosed above, such as between 0.5 μm and 100 μm including any range or value therebetween.

In some embodiments, the core-shell particle is in a form of a droplet. In some embodiments, the physical properties (shape, size) of the core-shell particles and the chemical constituents (e.g. ratios and the composition of the major/minor phase) of the w/o emulsion are as disclosed hereinabove for o/w emulsion.

In some embodiments, a weight ratio between the plurality of nanoparticles and an aqueous solvent within the core-shell particle or within the w/o emulsion of the invention is between 1:10 and 1:100, between 1:10 and 1:80, between 1:10 and 1:50, between 1:30 and 1:50, between 1:20 and 1:50, between 1:30 and 1:100, between 1:30 and 1:80, between 1:50 and 1:100, including any range between.

In some embodiments, each hydrophobic nanoparticle is a surface modified metal oxide particle. In some embodiments, the metal oxide comprises a divalent metal/metalloid oxide or a tetra-valent metal/metalloid oxide selected from silicon oxide, titanium dioxide, zirconia, or any combination thereof.

In some embodiments, each nanoparticle is a chemically modified metal oxide particle comprising a hydrophobic functional moiety covalently bound to the metal/metalloid oxide particle. In some embodiments, the hydrophobic functional moiety comprises (C1-C20)alkyl, (C1-C20)alkylsilyl, (C1-C4)alkylsilyl, phenyl, thiol group, vinyl, fluoroalkyl, haloalkyl, halogen, epoxy, a cycloalkane, an alkene, a haloalkene, an alkyne, an ether, a silyl group, a siloxane group, and a thioether or any combination thereof.

In some embodiments, the hydrophobic nanoparticles are characterized by a contact angle above 120°, 125°, 130°, 135°, including any range or value in between.

In some embodiments, the hydrophobic functional moiety comprises a UV-shielding group, wherein the UV-shielding group is as described hereinabove.

In some embodiments, the hydrophobic nanoparticles are characterized by an average (e.g., arithmetic mean) particle size of 1 nm to 900 nm. In some embodiments, the average particle size of the hydrophobic nanoparticles is between 2 nm to 600 nm, 2 nm to 550 nm, 2 nm to 520 nm, 2 nm to 500 nm, 2 nm to 480 nm, 2 nm to 450 nm, 2 nm to 400 nm, 2 nm to 350 nm, 2 nm to 300 nm, 2 nm to 250 nm, 2 nm to 200 nm, 2 nm to 150 nm, 2 nm to 100 nm, 5 nm to 600 nm, 10 nm to 600 nm, 15 nm to 600 nm, 20 nm to 600 nm, 40 nm to 600 nm, 50 nm to 600 nm, 100 nm to 600 nm, 5 nm to 500 nm, 10 nm to 500 nm, 15 nm to 500 nm, 20 nm to 500 nm, 40 nm to 600 nm, 50 nm to 500 nm, 100 nm to 500 nm, 5 nm to 400 nm, 10 nm to 400 nm, 15 nm to 400 nm, 20 nm to 400 nm, 40 nm to 400 nm, 50 nm to 400 nm, 100 nm to 400 nm, 5 nm to 50 nm, 5 nm to 40 nm, 2 nm to 50 nm, or 2 nm to 40 nm, including any range therebetween. In some embodiments, the size of at least 90% of the hydrophobic nanoparticles varies within a range of less than ±25%, ±20%, ±15%, ±19%, ±5%, including any value therebetween. In some embodiments, the average particle size is as determined by SEM.

In some embodiments, a w/w concentration of the hydrophobic nanoparticles within the w/o emulsion is between 0.5 and 10%, between 0.5 and 5%, between 0.8 and 10%, between 0.8 and 5%, between 0.9 and 10%, between 0.9 and 5%, between about 1 and 10%, between about 1 and 5%, between about 1 and 3%, between about 3 and 10%, between about 2 and 5%, between 5 and 10%, including any range between. In some embodiments, a w/w concentration of the nanoparticles affects the viscosity of the composition.

In some embodiments, a w/w ratio between the oil and the aqueous solvent within the w/o emulsion is between 70:30 and 40:60, between 70:30 and 45:65, between 70:30 and about 50:50, including any range between.

In some embodiments, the gelation agent comprises a natural or a synthetic polymer (optionally crosslinked via a covalent, or a non-covalent crosslinker) configured to form a gel in the presence of water. Non-limiting examples of gelation agents include but are not limited to polyacrylic acid, polyvinyl alcohol, polyethylene glycol, a polysaccharide (e.g. a gum, alginate, chitosan, pectin, hyaluronic acid, etc.), poly(2-hydroxyethyl methacrylate), polyacrylamide, including any salt thereof, or any combination thereof.

In some embodiments, a w/w concentration of the gelation agent within the composition is between 0.5 and 5%, between 0.5 and 10%, between 0.2 and 10%, between 0.8 and 5%, between 0.9 and 5%, between about 1 and 5%, between about 1 and 3%, between about 3 and 5%, between about 2 and 5%, between 0.5 and 4%, including any range between.

In some embodiments, a w/w concentration of the gelation agent affects the viscosity of the composition. In some embodiments, a w/w concentration of the gelation agent predetermines the viscosity of the composition, and further predetermines the water evaporation rate within the core-shell particle of the invention. In some embodiments, the presence of the gelation agent substantially maintains the water content encapsulated within the core-shell particles (e.g. upon application of the o/w composition to a plant/habitat). of the

In some embodiments, a w/o emulsion of the invention comprising between 0.5 and 10% w/w, or between 1 and 3% w/w of the hydrophobic nanoparticles; between 0.2 and 10% w/w of the gelation agent, and a w/w ratio between the oil and the aqueous solvent as described herein, is stable (e.g., devoid of phase separation, etc.) for a time period described herein. In some embodiments, composition stability is as described above.

In some embodiments, the entomopathogenic organism is viable within the w/o emulsion of the invention. In some embodiments, the entomopathogenic organism is viable within the w/o emulsion of the invention, and/or the entomopathogenic organism is viable upon application of the w/o emulsion of the invention to the plant/plant part; and/or to the area under cultivation. The term “viable” is as disclosed above.

In some embodiments, the entomopathogenic organism is as described above.

### Pesticide Compositions

In some embodiments, the composition of the invention is a pesticide composition.

In some embodiments, the pesticide composition of the invention (i.e., o/w, w/o emulsion) is characterized by substantial retention time on top of the plant and/or a part thereof. In some embodiments, the retention time is sufficient for maintaining at least 30%, at least 50%, at least 70%, at least 90% of the initial pesticidal activity of the composition (referred to the activity at the day of application), including any range between. In some embodiments, the retention time is at least 1 day (d), at least 2 d, at least 5 d, at least 7 d, at least 10 d, at least 15 d, at least 30 d, including any range between. In some embodiments, the composition of the invention remains stably bound (physically stable) or in contact with the plant, and/or with a part of the plant when exposed to ambient conditions at the area under cultivation (e.g., exposure to UV light, rain, moisture, temperatures of between 0 and 50° C., etc.). In some embodiments, the composition of the invention forms a coating layer on a plant and/or a part thereof; when applied to the plant or to the habitat.

In some embodiments, the coating layer comprising the composition and/or the pesticidal composition in contact with or adhered to a plant and/or a part thereof, is stable to climatic changes. In some embodiments, the coating layer substantially prevents environmental damage (e.g., due to ambient conditions such as temperature changes, heat, cold, UV radiation and atmospheric gases) to the entomopathogenic organism. In some embodiments, a coating layer substantially preserves pesticidal activity of the entomopathogenic organism upon exposure to environmental damage for a time period describe herein. In some embodiments, the coating layer is stable to temperature changes, heat, cold, UV radiation and atmospheric gases. In some embodiments, the pesticidal properties and/or stability of the coating layer are not affected or altered by climatic changes as described herein.

In some embodiments, the pesticide composition, or the composition of the invention (i.e., o/w, w/o emulsion) is characterized by a viscosity of between 10² and 10⁵ cP, between 10² and 10⁴ cP, between 10² and 10³ cP, between 10³ and 10⁴ cP, between 10⁴ and 10⁵ cP, including any range between.

In some embodiments, the viscosity of the pesticide composition is sufficient for stabilizing thereof, thereby resulting in a composition characterized by stability for at least 1 month (m), at least 2 m, at least 6 m, at least 10 m, at least 12 m, at least 24 m, at least 36 m, including any range between.

In some embodiments, stability of the composition is referred to a prolonged storage thereof under suitable storage conditions comprising inter alia: ambient atmosphere and a temperature of less than 30° C., less than 20° C., less than 15° C., less than 10° C., less than 5° C., less than 2° C., less than 0° C., including any range between. In some embodiments, the suitable storage conditions comprise a low storage temperature sufficient for substantially preventing germination of microbial spores. In some embodiments, the term “stable” is as described herein.

In some embodiments, the pesticide composition is in a form of (i) oil-in-water emulsion, and/or oil in-water Pickering emulsion, (ii) water-in-oil emulsion, and/or water-in-oil Pickering emulsion, comprising the entomopathogenic organism. In some embodiments, the composition of the invention is characterized by a prolonged pesticidal activity and/or prolonged residence time on a plant (or a part thereof) and/or within the area under cultivation, as compared to a non-encapsulated entomopathogenic organism (e.g., a similar entomopathogenic organism dispersed in an aqueous solvent without the core-shell particles of the invention).

In some embodiments, the term “prolonged” as used herein, is by at least 1 d, at least 5 d, at least 10 d, at least 15 d, at least 20 d, at least 30 d, including any range between. In some embodiments, the composition of the invention substantially prevents damage to the entomopathogenic organism for a time period between 1 d and 60 d, between 1 d and 10 d, between 1 d and 5 d, between 10 d and 20 d, between 20 d and 30 d, between 30 d and 40 d, between 40 d and 60 d, including any range between (e.g., when exposed to outdoor conditions).

In some embodiments, the pesticide composition comprises an agriculturally acceptable carrier. In some embodiments, the aqueous solvent of the pesticide composition is an agriculturally acceptable solvent.

In some embodiments, the pesticide composition of the invention comprises a pesticide effective amount of entomopathogenic organisms, wherein the entomopathogenic organisms are characterized by a pesticide activity as described herein. In some embodiments, the pesticidal effective amount is sufficient for reducing plant damage associated with the pest, reducing growth and/or reducing pest loading on a plant or within the area under cultivation, wherein reducing comprises any statistically significant reduction, such as by at least 5%, at least 10%, at least 15%, at least 20%, at least 25%, at least 30%, at least 40%, at least 50%, at least 60%, including any range therebetween.

In some embodiments, the pesticide effective amount comprises a concentration of the entomopathogenic organism within the pesticide composition of the invention of at least 5%, at least 10%, at least 15%, at least 20%, at least 25%, at least 30%, at least 40% v/v, including any range therebetween.

In some embodiments, the pesticide effective amount comprises a concentration of entomopathogenic organism within the pesticide composition of the invention of between 10 and 1,000,000, between 10 and 100,000, between 100 and 100,000, between 100 and 10,000, between 100 and 5000, between 500 and 5000, at least 100, at least 500, at least 1000 units/ml, including any range therebetween. The term “units/ml” refers to the number of entomopathogenic organisms per ml of the composition.

In some embodiments, the pesticide composition of the invention is a liquid composition formulated for application on an infested plant or a part thereof or to an infested area under cultivation such as infested soil. In some embodiments, the plant and/or the soil is infested with a pest such as a plant pathogen, soil pathogen or both. In some embodiments, the pesticide composition of the invention is formulated (e.g., characterized by a suitable viscosity, as described herein) for application by any of spraying, fogging, fumigation, and coating including any combination thereof.

In some embodiments, the pesticide composition is for use as: a UV protective coating, an anti-insect composition, a plant protective composition, or any combination thereof.

### The Article

According to some embodiments, the present invention provides an article comprising a substrate in contact with the composition of the invention, or in contact with the entomopathogenic organism coated by or in contact with the core-shell particles of the invention. In some embodiments, the entomopathogenic organism coated by or in contact with the core-shell particles of the invention is also referred to herein as an “encapsulated entomopathogenic organism”.

In some embodiments, the encapsulated entomopathogenic organisms are bound to the substrate. In some embodiments, the encapsulated entomopathogenic organisms are mixed with the substrate. In some embodiments, the encapsulated entomopathogenic organisms are in a form of a coating layer on the substrate. In some embodiments, the coating layer is substantially homogeneous layer. In some embodiments, the coating layer is homogenously distributed on at least a portion of the substrate.

In some embodiments, the coating layer is characterized by an average thickness of between 1 and 100 um, between 1 and 10 um, between 10 and 20 um, between 2 and 50 um, between 50 and 100 um, including any range between.

According to some embodiments, the present invention provides an article comprising the liquid composition of the present invention. In some embodiments, the article comprises the liquid composition (e.g., oil in water emulsion) within a package. In some embodiments, the package is or comprises a container suitable for holding a liquid volume.

In some embodiments, the substrate is selected from a plant or a plant part (e.g., a leave, a stem, a fruit, etc.), soil, a polymeric substrate, glass substrate, a metallic substrate, a paper substrate, a carton substrate, a polystyrene substrate, a tissue-based substrate, a brick wall, a sponge, a textile, a non-woven fabric, or wood. In some embodiments, the substrate is or comprises an edible matter.

In some embodiments, the article or the coating layer is stable. In some embodiments, the coating layer is characterized by an average thickness of 100 nm to 500 μm, 100 nm to 400 μm, 100 nm to 300 nm, 300 nm to 500 nm, 500 nm to 1000 nm, 250 nm to 400 μm, 500 nm to 400 μm, 900 nm to 400 μm, 1 μm to 400 μm, 10 μm to 400 μm, 50 μm to 400 μm, 100 μm to 400 μm, 250 μm to 400 μm, 10 nm to 100 μm, 25 nm to 100 μm, 50 nm to 100 μm, 100 nm to 100 μm, 250 nm to 100 μm, 500 nm to 100 μm, 900 nm to 100 μm, 1 μm to 100 μm, 10 μm to 100 μm, 50 μm to 100 μm, 10 nm to 10 μm, 25 nm to 10 μm, 50 nm to 10 μm, 100 nm to 10 μm, 250 nm to 10 μm, 500 nm to 10 μm, 900 nm to 10 μm, or 1 μm to 10 μm, including any range therebetween.

As used herein the term “stable” refers to the capability of the article (e.g., a coated substrate) to maintain its structural and/or mechanical integrity such as being devoid of cracks and/or deformations. In some embodiments, the article is referred to as stable, if the article substantially maintains its structural and/or mechanical integrity under outdoor conditions such as a temperature-25 and 75° C., UV and/or visible light irradiation. In some embodiments, the stable article is rigid under outdoor conditions. In some embodiments, the stable article maintains its tensile strength and/or elasticity. In some embodiments, substantially is as described hereinbelow.

In some embodiments, the coating layer is stable at a temperature range of −100° C. to 100° C., −50° C. to 100° C., −10° C. to 100° C., −10° C. to 50° C., 0° C. to 100° C., 0° C. to 50° C., 5° C. to 60° C., 0° C. to 10° C., 10° C. to 100° C., 50° C. to 100° C., 10° C. to 50° C., 10° C. to 70° C., 5° C. to 60° C., including any range therebetween.

In some embodiments, the article comprises an outer surface and an inner surface, wherein the outer surface is in contact with or bound to the coating layer, as described herein.

In some embodiments, the composition of the invention is characterized by an adhesiveness property to the substrate.

In some embodiments, the coating layer is pesticide coating. In some embodiments, the coating layer has at least one characteristic selected from: an anti-fungal coating, an anti-microbial coating, an anti-insect coating, an anti-viral coating, an anti-mold coating, a plant protective coating, and a pesticide coating.

In some embodiments, the article or the pesticide composition of the invention is capable of reducing at least one of: (i) growth of the pest, and (ii) pest load on or within the substrate by at least 10%, at least 20%, at least 30%, at least 40%, at least 50%, at least 70%, at least 100%, including any range between compared to a control. In some embodiments, the article or the pesticide composition of the invention is capable of reducing at least one of (i) growth of the pest, and (ii) pest load at the application area (e.g., an area under cultivation and/or the substrate located in close proximity to the application site). In some embodiments, the control is a similar substrate being devoid of the pesticide composition of the invention (e.g., infested substrate which has not been treated by any pesticide composition). In some embodiments, the pesticide coating is capable of reducing pest load and/or pest growth by a factor ranging between 2 and 20, between 2 and 5, between 5 and 7, between 7 and 10, between 10 and 12, between 12 and 15, between 15 and 20, including any range between. In some embodiments, reducing is compared to the control.

In some embodiments, the coating layer according to the present invention, is stable under ambient conditions. In some embodiments, the coating layer is stable upon exposure to: an ambient temperature and/or temperature changes, heat, cold, UV radiation and atmospheric gases. In some embodiments, the characteristics of the coating layer are not affected or altered by climatic changes as described herein. In some embodiments, the article according to the present invention, is stable to climatic changes. In some embodiments, the article is stable to temperature changes, heat, cold, UV radiation and atmospheric corrosive elements. In some embodiments, the characteristics of the article (e.g., pesticide activity) are substantially not affected or altered by climatic changes as described herein.

In some embodiments, the article (e.g., a substrate coated by the pesticide composition) is stable for at least 1 d, least 5 d, at least 7 d, at least 10 d, at least 15 d, at least 30 d, at least 60 d, at least 100 d, at least 300 d, including any range between.

In some embodiments, the article is in a form of a kit (e.g., pesticidal or agricultural kit) comprising a first compartment comprising the nanoparticles and the oil, as described herein. In some embodiments, a w/w concentration of the nanoparticles within the oil is between 0.5 and 10%.

In some embodiments, the kit comprises a second compartment comprising the entomopathogenic organisms. In some embodiments, the second compartment further comprises an aqueous solvent (e.g. an agriculturally acceptable carrier). In some embodiments, a w/w concentration of the entomopathogenic organisms within the aqueous solvent is up to 80%, up to 60%, up to 50%, up to 20%, including any range between.

In some embodiments, the kit further comprises instructions for mixing the second compartment (e.g. comprising the EPN organism, or a composition comprising thereof) with the first compartment at a predetermined ratio, to obtain the composition of the invention.

### The Method

According to some embodiments, the present invention provides a method for controlling a pest or reducing growth thereof, comprising contacting an effective of the pesticide composition with a locus infested with the pest.

The term “locus” as used herein, means a habitat, plant, seed, material, or environment, in which a pest is growing, may grow, or may traverse. For example, a locus may be: crops, trees, fruits, cereals, fodder species, vines, and/or ornamental plants, a plant part, the interior or exterior surfaces of buildings (such as places where grains are stored); the materials of construction used in buildings (such as impregnated wood). In some embodiments, the terms “locus” and “area under cultivation” are used herein interchangeably. In some embodiments, the terms “locus” refers to a plant and/or to a part of the plant (e.g., a leaf).

In some embodiments, there is a method for preventing infestation by a pest, the method comprises applying an effective amount of the pesticide composition of the invention to at least a portion of a plant, and/or to an area under cultivation. In some embodiments, there is a method for controlling a pest or reducing growth thereof, comprising applying an effective amount of the pesticide composition of the invention to at least a portion of a plant, or an area under cultivation infested with the pest, thereby controlling or reducing growth of the pest.

In some embodiments, the method is for killing a pathogen or for reducing pathogen load. In some embodiments, the method is for killing a pathogen or reducing growth thereof by administering to a plant an effective amount of the pesticide composition described hereinabove. As used herein, the terms “pest” and “pathogen” are used herein interchangeably herein throughout.

In some embodiments, the term “reducing”, or any grammatical derivative thereof, indicates that at least 20%, 30%, 40%, 50%, 60%, 70%, 80%, 90%, or more, reduction of growth or even complete growth inhibition in a given time as compared to the growth in that given time of the pathogen not being exposed to the treatment as described herein. In some embodiments, the term “completely inhibited”, or any grammatical derivative thereof, refers to 100% arrest of growth in a given time as compared to the growth in that given time of the pathogen not being exposed to the treatment as described herein. In some embodiments, the terms “completely inhibited” and “eradicated” including nay grammatical form thereof, are used herein interchangeably.

In some embodiments, the pesticide composition of the invention is characterized by adhesiveness to at least a part of the plant.

In some embodiments, the plant comprises a cultivating plant or a part thereof.

In some embodiments, the pesticide composition of the invention is applied to a plant or to a part of a plant via a method comprising: immersion, coating, irrigating, dipping, spraying, fogging, scattering, painting, injecting, or any combination thereof.

In some embodiments, the pesticide composition of the invention is applied at any plant cultivation stage, such as seeding, pre-seeding, pre-harvest, post-harvest, storage, etc.

In some embodiments, the effective amount is sufficient for controlling a pest, killing a pest, reducing pest load, reducing pest growth, reducing a plant damage associated with the pest, preventing infestation of a plant and/or area under cultivation by the pest, or any combination thereof.

In some embodiments, the pesticide effective amount is of the liquid composition disclosed herein at least 1 L/ha, at least 10 L/ha, at least 50 L/ha, at least 100 L/ha, at least 500 L/ha, at least 1000 L/ha, at least 5000 L/ha, including any range between.

In another aspect, there is provided a method for obtaining a liquid formulation comprising a living organism, the method comprises providing a dispersion comprising the living organism and an aqueous solvent (e.g., an agriculturally acceptable carrier), and adding or contacting the dispersion with a mixture comprising the UV-shielding nanoparticles and the oil, thereby obtaining the liquid formulation. In some embodiments, the living organism is an invertebrate (e.g., an arthropod, an insect, an aphid, a nematode, or any combination thereof). In some embodiments, the method is for coating the living organism with the core-shell particles of the invention. In some embodiments, the method is for binding the core-shell particles of the invention to the living organism. In some embodiments, the method is for dispersing or formulating the living organism in an emulsion (e.g., w/o or o/w emulsion).

In some embodiments, the method is as described herein, wherein a w/w concentration of the UV-shielding nanoparticles within the oil is between 0.5 and 10%. In some embodiments, the method is as described herein, wherein a w/w concentration of the entomopathogenic organisms within the aqueous solvent is up to 80%, up to 60%, up to 50%, up to 20%, including any range between.

In some embodiments, the method is for prolonging a shelf-life of an aqueous composition comprising the living organism.

### General

As used herein the term “about” refers to ±10%.

The terms “comprises”, “comprising”, “includes”, “including”, “having” and their conjugates mean “including but not limited to”.

The term “consisting of means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “substantially” refers to at least 85%, at least 90%, at least 92%, at least 95%, at least 96%, at least 97%, at least 98%, at least 99% including any range or value therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

As used herein, the term “treating” includes abrogating, substantially inhibiting, slowing or reversing the progression of a condition, substantially ameliorating clinical or aesthetical symptoms of a condition or substantially preventing the appearance of clinical or aesthetical symptoms of a condition.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

### Material and Methods

Titania (AEROXIDE TiO₂ P25, with an estimated primary particle size of 21 nm, obtained from Evonik, Germany), (3-Aminopropyl) triethoxysilane (99% Sigma-Aldrich, USA), mineral oil (RTM-10, Sigma-Aldrich, USA), ultrapure deionized water (ULS/MS grade), Triton X-100 (laboratory grade, Sigma-Aldrich, USA), Ethanol absolute and Ethanol-96% (Bio Lab, Israel).

Silanization of Titania (TiO₂) nanoparticles with APTES (NH₂)

TiO₂ (5.63 g) was added to 130 mL of ethanol and stirred until complete dispersion. Then, 11 mL of APTES was added slowly to the solution. The reaction was carried out at ambient temperature for 1.5 h. After salinization, particles were collected by centrifugation (9000 rpm, 10 min) and rinsed four times with ethanol. Finally, TiO₂—NH₂ NPs were dried at 35° C. under vacuum for 3 h.

TiO₂—NH₂ Pickering Emulsion Preparation

Pickering emulsions were prepared from amine-functionalized TiO₂ in water and mineral oil. First, TiO₂—NH₂ NPs were dispersed in deionized water by sonication for 5 min (Sonics Vibra-Cell 750 W, 25% amplitude) with increasing TiO₂ content: 0.4, 1 and 2 wt %. Then, mineral oil was added at oil/water ratios of 10:90, 30:70, 40:60 and 50:50 vol %, respectively. The mixture was sonicated for 10 min for emulsification (Sonics Vibra-Cell 750 W, 35% amplitude).

TiO₂—NH₂ Particles Labeling with Carboxyfluorescein

To label the TiO₂—NH₂ particles, MES buffer (pH 3) was used at a concentration of 0.5 M. 5(6)-Carboxyfluorescein was added to the MES buffer at a concentration of 0.1 mg/ml to prepare a dye solution. EDC was added to the MES buffer at a concentration of 15 mg/ml to prepare a reaction catalyst solution. To obtain an amide reaction, 100 mg of TiO₂—NH₂ particles (powder) were added to a 0.1 ml dye solution, a 0.3 ml catalyst solution, and a 0.6 ml MES buffer. The powder was mixed thoroughly until the particles were fully dispersed using a magnetic stirrer for one hour at room temperature. Following the amide reaction, the particles were collected by centrifugation (9500 rpm, 20 min) rinsed with MES buffer five times, and then finally rinsed with distilled water. Then, the labeled TiO₂—NH₂ particles were dried at 35° C. under vacuum (70 mmHg) for three days.

### High-Resolution, Cryogenic Scanning Electron Microscopy

Pickering emulsion samples were analyzed using a High-resolution Cryo SEM JSM-7800F Schottky field-emission scanning electron microscope (Jeol, Ltd.; Tokyo, Japan) equipped with a cryogenic system (Quorum pp 3010, Quorum Technologies, Ltd.; Laughton, UK). Liquid nitrogen was used in all the heat-exchange units of the cryogenic system. A 2 μl of the emulsion were placed on the sample holder between two rivets and vitrified using liquid nitrogen. The sample was then transferred to the preparation chamber where it was fractured (−140° C.). The revealed fractured surface was sublimed at −90° C. for 10 min, to eliminate any presence of condensed ice, and then coated with platinum. The temperature of the sample was kept at −140° C. Images were acquired with a low electron detector (LED) at an accelerating voltage of 5.0 kV and a working distance of 3.9 mm.

The instability index of creaming separation was analyzed using LUMiSizer® software (L.U.M. GmbH, Berlin Germany), and calculated with the included software (SepView 6.0; LUM). The polycarbonate cuvettes with a 2 mm optical path length filled with 400 μL of 40:60 and 50:50 vol % with 2 wt % of TiO₂—NH₂ emulsions and were centrifuged in triplicate at 25° C. simultaneously at a centrifugal force of 600 rpm. The transmission profiles were captured at 865 nm throughout the cell for 6 hours (200 profiles every 5 s, 100 profiles every 10 s, 100 profiles every 30 s and 600 profiles every 60 s).

### Nematode Preparation

Steinernema carpocapsae (Weiser) originating from the commercial product Nemastar (e-nema, GMBH, Schwentinental, Germany) were routinely propagated on last instars of Galleria mellonella (L.) and were maintained in the lab at Volcani center. Freshly emerging S. carpocapsae IJs were collected from modified White trap and stored at 8° C., used within 20 days from emergence. The nematodes were vacuum filtered on filter paper, allowed to pass through 30 μm mesh, collected in distilled water and labelled as nematode stock solution. The number of IJs in 20 μl of the stock solution was counted twice to determine the nematode concentration. The stock solution was diluted to a concentration of 1000±100 nematodes/ml.

### Nematode Addition to TiO2-NH2 Emulsion

S. carpocapsae IJs from stock solution were centrifuged at 1500 rpm for 5 minutes. The supernatant was discarded. The required volume of emulsion (10 ml) was added and gently mixed. The IJ concentration was maintained at 1000±100 nematodes/ml. The IJ were stored in falcon tubes for the shelf life study and for infectivity, where they were used immediately.

### Scanning Electron Microscope (SEM)

SEM measurements were performed using a MIRA3 field-emission SEM microscope (TESCAN, Brno/Czech Republic) with an acceleration voltage of 1 and 3 kV and a secondary electron detector. Pickering emulsion samples were drop-cast on a conductive double stick carbon tape and dried under ambient conditions. Prior to imaging, a thin layer of palladium/gold was evaporated onto them to render them electrically conductive and to avoid surface charging by the electron beam.

### Nematode Shelf-Life

Two TiO₂—NH₂ emulsions (4:6 and 5:5) along with control (nematodes in water) added with S. carpocapsae were stored at 8° C. The concentration of IJ for all treatments was maintained at 1000±100 IJ/ml and volume was 10 ml. The survival of IJs in TiO₂ emulsions and control were determined at 15 day intervals. The sample (20 μl) was diluted with 7 ml of distilled water. The samples were observed in stereomicroscope (Olympus, SZH10) and counted. The IJs were scored dead when no movement was observed after probing with a needle. Each treatment contained five technical replicates and experiments were repeated twice. Each treatment and time points, a range of 25-125 IJ were counted.

### Insect Bioassay of IJs in TiO2-NH2 Emulsions

A Galleria mellonella colony is maintained in the lab at Volcani center continuously. For the bioassay, 5th instars were collected from the colony. TiO₂—NH₂ emulsions (4:6 and 5:5) with S. carpocapsae IJ (500 μl) were loaded on Petri plates (90 mm) lined with a single layer of filter paper (Whatman no. 1). Other treatments included S. carpocapsae in water, only emulsions (40:60 and 50:50) and negative control of only water. Five G. mellonella were added per plate for each treatment and sealed with parafilm. The experimental set-up was incubated at 23° C. for 48 hours. Insect mortality was recorded after additional 48 hours. Each treatment contained five replicates and the experiment was repeated thrice.

From each treatment, the dead larvae were transferred to modified White trap and incubated at 23° C. for evaluation of IJs yield per G. mellonella. The emerging IJs were collected per week. The collected (20 μl) IJ solution was added to 7 ml of water in persipex and counted in stereomicroscope. The total number of IJs emerged were calculated based on the volume of the collected solution and only live IJ were considered in the counting. Each treatment contained five replicates and the experiment was repeated twice. The data represented is a cumulative average of two biological repeats.

### Confocal Microscopy of the Formulated Nematodes

The samples were analyzed by laser scanning confocal microscopy. For 3D image acquisition, a Leica SP8 laser scanning microscope (Leica, Wetzlar, Germany) was used, equipped with a solid state laser with 488 nm light, HC PL APO CS 20×/0.75 objective (Leica, Wetzlar, Germany) and Leica Application Suite X software (LAS X, Leica, Wetzlar, Germany). The GFP signal was imaged using the argon laser, and the emission was detected in a range of 500-520 nm. For S. carpocapsae, image stacks were first projected using a Z projection (at maximum intensity) to find all the fluorescent nematodes and the images were analysed using Fiji software. A fluorescent emission of carboxyfluorescein emission signals was recorded with PMT and HyD (hybrid) detectors in ranges of 500-530.

### Statistical Analysis.

Data obtained as percentages were arcsine transformed prior to the statistical analysis using SPS software (JMP professional 15.0). ANOVA was used to identify general effects and interactions. Tukey's HSD (Honestly Significant Difference) test was performed for multiple comparisons (P<0.05). The effects on IJs yield/larva were analyzed using one-way ANOVA and means were compared using Tukey-kramer HSD test.

### Example 1

### Pickering Emulsion Preparation and Characterization

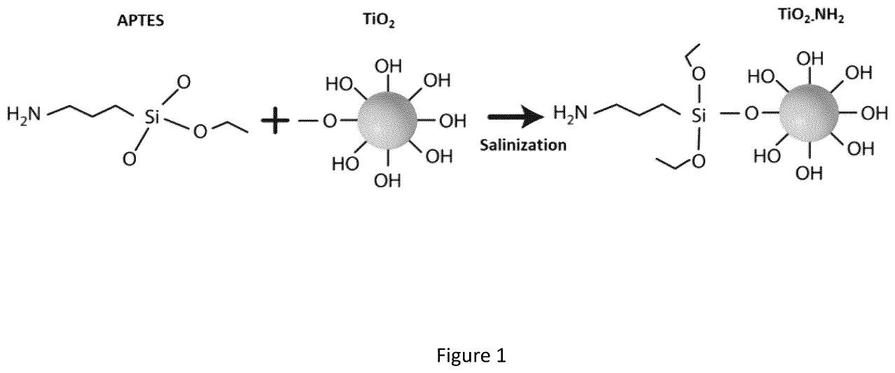

TiO₂ NPs were functionalized by NH2 by salinization (or silanization) to introduce amine groups on the surface of the NPs as schematically presented by FIG. 1.

Oil-in-water Pickering emulsions stabilized by amine-functionalized TiO2 NPs were prepared. Different amine-functionalized TiO2-NH2 content and oil/water ratios were implemented to determine the optimal conditions for a stable Pickering emulsion system that would meet the requirements of nematode formulation. The TiO2-NH2 content varied (0.4, 1, and 2 wt %) at oil/water ratios of 10:90, 30:70, 40:60 and 50:50, respectively.

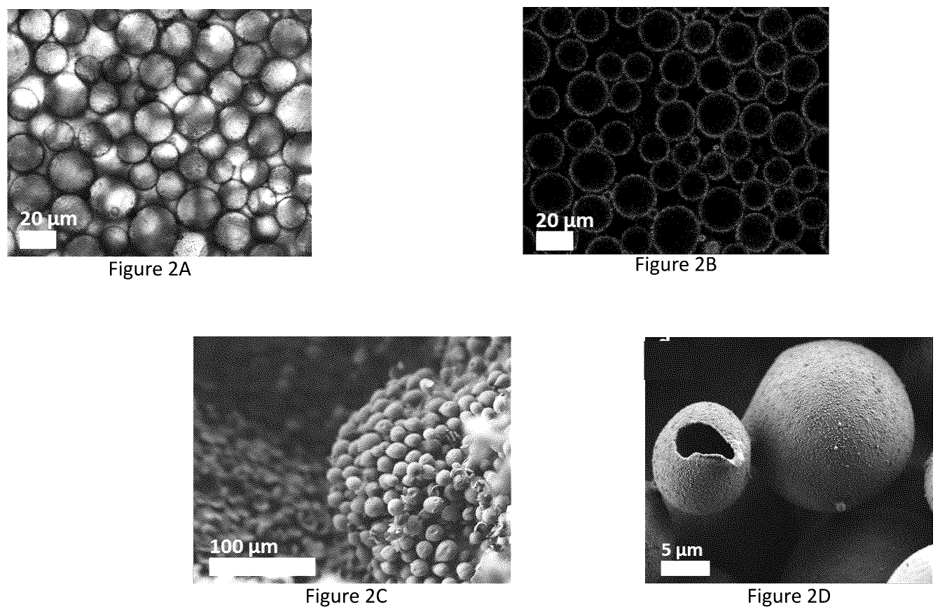

The structure of the emulsions was characterized using confocal microscopy and cryo-HRSEM (FIG. 2). To investigate the location of the TiO2-NH2 particles in the emulsion, we used TiO2-NH2 particles that were covalently labeled with the fluorescent dye carboxyfluorescein. The dye was covalently immobilized on the TiO2-NH2 particles by amidation (EDC-NHS), through the amine end of the APTES molecules. The carboxyfluorescein dye is excited at a wavelength of 488 nm and has an emission of 500-530 nm, which gives it a green color. The confocal microscopy analysis (FIGS. 1A-1B) confirmed the self-assembly of the TiO2-NH2 particles at the oil/water interface, as the green fluorescent signal formed rings around the oil droplets, indicating that the particles were indeed located at the interface as the Pickering stabilizer.

Adjusting the emulsion composition served to fine-tune the resulting droplet size, which is essential for obtaining proper coating of the nematodes. The relatively high stability of the Pickering emulsion can thus be ascribed to the low coalescence rate of the droplets.

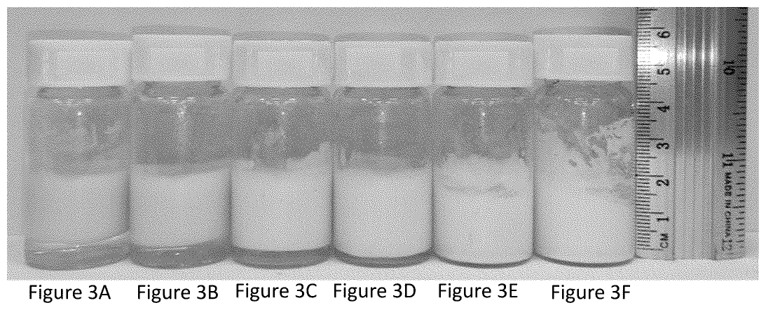

A LUMisizer (LUM GmbH, Germany) assessed the stability of the Pickering emulsions over time, confirming visual inspection. Most of the prepared emulsions were stable for 7 days. TiO₂—NH₂ content of 0.4, 1 and 2 wt % at oil/water ratios of 40:60 and 50:50 oil:water volume fractions had the highest stability, which were maintained for more than 5 months (FIG. 3A-3F).

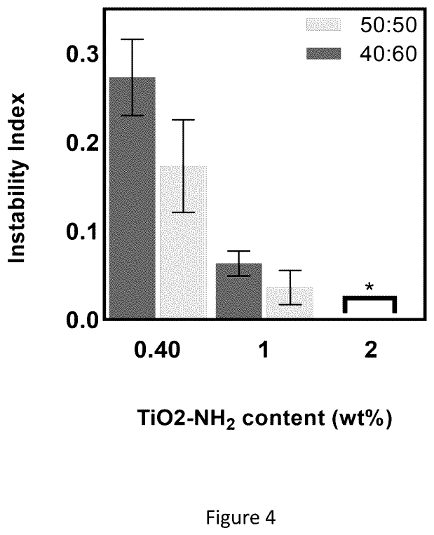

The stability of the emulsions was characterized quantitatively by calculating the instability index using a LUMiSizer. Light transmission was measured during centrifugation of the emulsions, which were added to cuvettes at 25° C. Results revealed a positive correlation between particle content and stability, where an increase in TiO₂—NH₂ content resulted in increased stability (FIG. 4). Emulsions with 2% TiO₂—NH₂ content at different oil/water ratios were found to be the most stable. Instability indices between 50:50 and 40:60 oil/water ratios was not significantly different for any of the TiO₂—NH₂ content. The most stable emulsion was obtained with 2% TiO₂ at 40:60 and 50:50 an oil/water volume fractions, which had the smallest droplet size and the lowest instability index. Emulsions with 2 wt % TiO₂—NH₂ content at different oil/water ratios were found to be the most stable and suitable for individual formulation of nematodes due to the small size of droplets.

### Example 2

### Formulation of EPNs in Pickering Emulsion

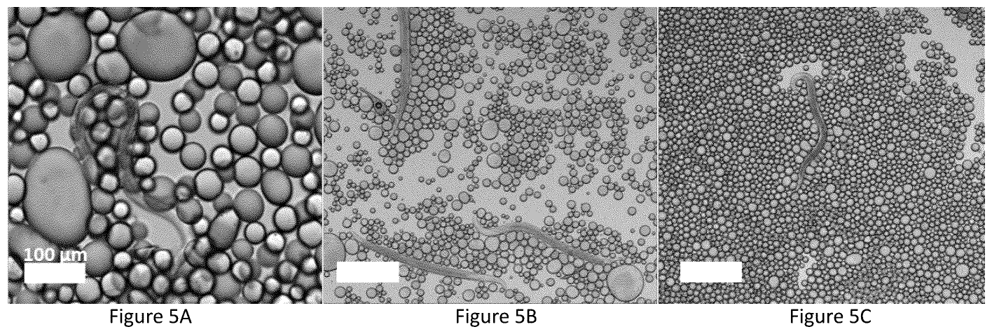

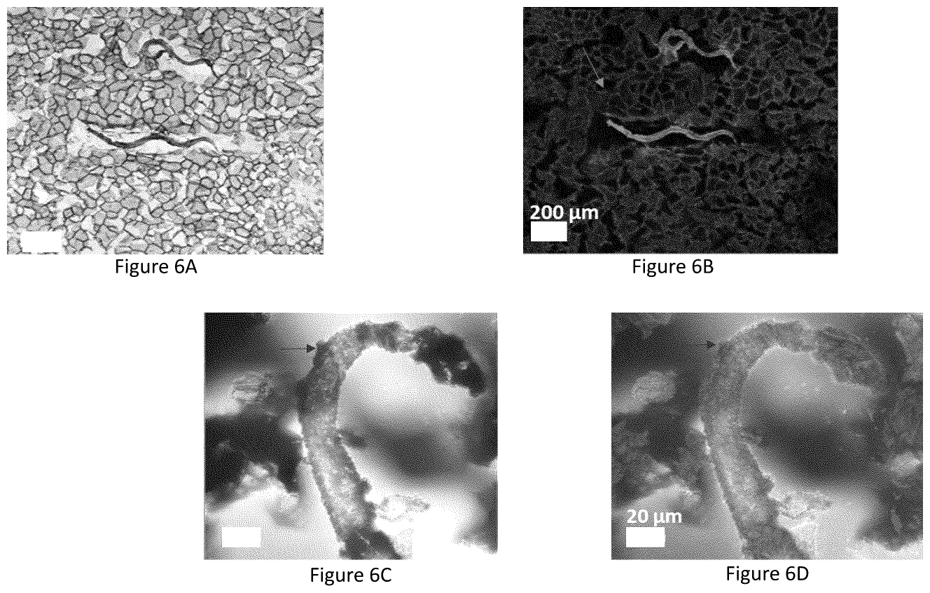

The 200 μl of S. carpocapsae nematode suspensions were precipitated during 15 minutes in the Eppendorf tube (1.5 ml). Pickering emulsions (400 μl) with 0.4, 1 and 2% of TiO₂—NH₂ at 40:60 oil:water volume fractions were added to the nematode residues. Confocal microscopy micrographs showed that successful incorporation of the nematode was observed between the droplets in all formulations (FIG. 5). Moreover, confocal images in show that smaller droplets create coating better coating ability due to higher contact area with the nematodes (FIG. 6). As described, the most stable emulsion and with smallest droplet size were with 2% TiO₂—NH₂ at 40:60 and 50:50 oil/water ratios (FIGS. 4, 5). Therefore, Pickering emulsions containing 2% TiO₂—NH₂ at 40:60 and 50:50 oil:water volume fractions were found to be the most suitable formulations.

Confocal analysis of dried formulations were carried using Pickering emulsion with green labeled particles using carboxyfluoresceine. An aliquot of 200 μl of S. carpocapsae nematode suspension were precipitated for 15 minutes in an Eppendorf tube (1.5 ml). After which, 400 μl of emulsions were added to the nematode residue. 30 μl of the nematode formulation were then dried at 25° C. on a glass slide for analysis. FIGS. 6A-6B demonstrate the successful incorporation of dried nematode between oil droplets. The green color marks the TiO₂—NH₂-carboxyfluoresceine NPs at the interface. FIGS. 6B-6C demonstrate 3D images of the dried formulation. These pictures illustrate that nematodes were fully coated with the labeled NPs. During the drying process, the oil droplets were sticking to each other due to water evaporation. This phenomenon contributed to the spreading of TiO₂ on nematode surface.

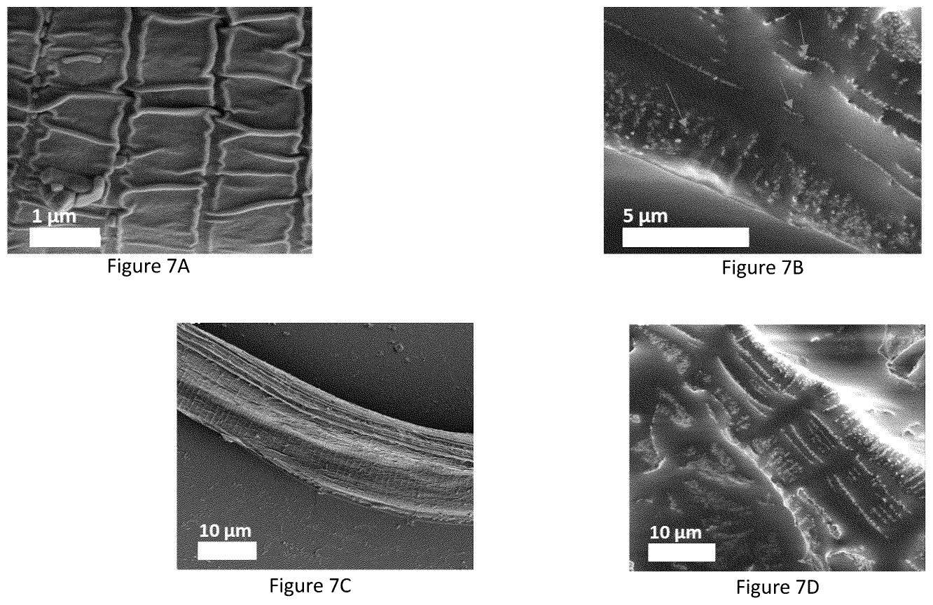

SEM analysis of formulated EPNs in Pickering emulsion showed that nematodes were coated with mineral oil of Pickering emulsion successfully (FIG. 7). It was observed that TiO₂ nanoparticles were deposited majorly along the striations or lines on the nematode body after drying. In our preliminary analysis, this region shrank with desiccation. This may provide hypothesis for possible protection of nematodes rendered by the formulation against stress conditions.

### Example 3

### Nematode Shelf-Life

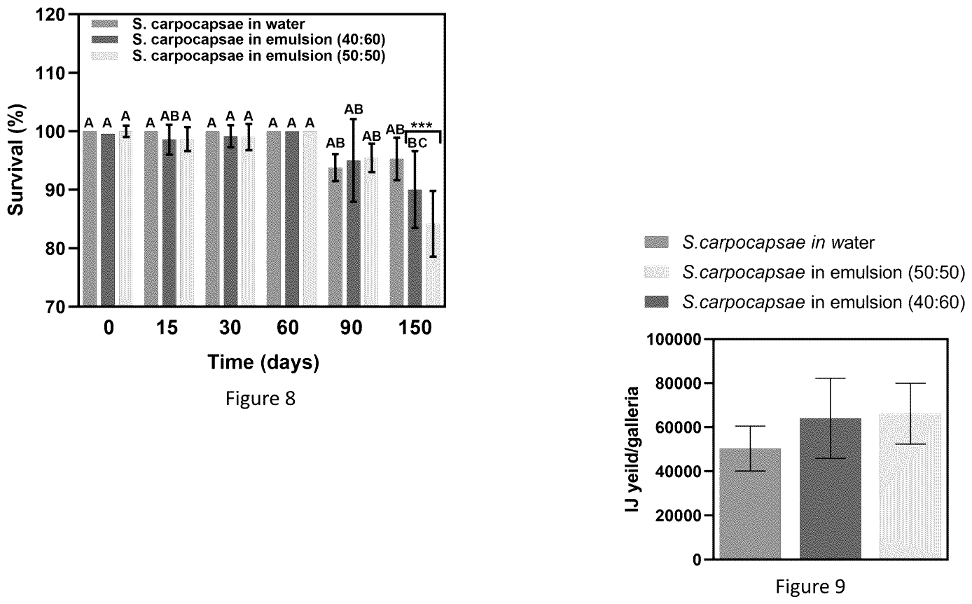

The S. carpocapsae nematodes were suspended into Pickering emulsions with 2% TiO₂—NH₂ at 40:60 and 50:50 oil-water-ratio. Formulation were evaluated for their shelf life by monitoring the IJ's survival at 8° C. every 15 days for a month, then once a month for 5 months. On the first day, the survival in the 50:50 Pickering emulsion recorded a slight difference with no statistical differences. At 60 days post treatment, both formulations demonstrated similar survival rates of IJs to control samples of S. carpocapsae in water (P>0.05) (FIG. 8). Nematode survival was higher than 98% in all treatments, indicating that the environment in TiO₂—NH₂ Pickering emulsion is similar to water.

### Effect of UV Radiation on IJs Viability

The inventors further tested the effect of UV radiation on IJ viability in water versus the formulations of the invention by subjecting each tested sample to a UV light (254 nm) in a Labconco Purifier Class II Biosafety Cabinet (model 36209; Labconco, Kansas City, MI) for 10 or 20 min.

The formulations used in the tests include Barricade® II Fire Blocking Gel in 1% or 2% concentration and an exemplary composition of the invention (see Example 1). Nanoparticle formulations were produced at Institute for Postharvest and Food Science, Volcani Center, Agricultural Research Organization, Israel.

To prepared IJs suspensions used in various treatments, IJ suspensions in 5 ml of distilled water placed in a 15-ml centrifuge tube were centrifuged at 2000 rpm for 2 min. The water was carefully removed, and the IJs pellet of approximately 100 μl at the tube bottom was used to make the IJ formulations at the concentration of 1000 IJs/ml. For IJs in 1% and 2% Barricade, 100-μl IJs pellet was first mixed with distilled water, shaken well, and then added with 0.1 and 0.2 g of Barricade gel, respectively, for a final volume of 10 ml for each replicate tube. Approximately 2 ml of IJs suspensions were pipetted to the center of 60-mm Petri dish lid. Due to the thick textures of Barricade formulation, the mixtures were transferred using a spatula and weighed for approximately 2 g. The dishes were arranged under the UV light randomly and exposed to UV light for 10 or 20 min.

After UV treatment, the dishes were placed at 25° C., LD 14:10 in a growth chamber for 24 h. The amount of water loss was compensated by weighing the dishes before and after incubation. The IJ suspensions were mixed; 1 ml of solution was used to evaluate IJ virulence, and the rest was used to assess IJ mortality. The number of live and dead IJs were counted under a microscope, and IJs that did not respond to probing were considered as dead. There were approximately 100 IJs examined in each sample. There were three replicate dishes per treatment, and the whole experiment was conducted three times.

For evaluating IJs virulence after UV exposure, control formulations (without IJs) were included as: water, 1% and 2% Barricade, and TiO₂ formulation. Following UV treatment and 24 h incubation at 25° C., 1 ml of IJs suspension (or 1 g for IJs in Barricade) was taken from each dish and transferred to a 100-mm Petri dish containing a single layer of filter paper, and 10 last instar larvae of G. mellonella were added to each plate. The plates were placed on a tray and covered with a plastic bag with moist paper towel of keep moisture. Insect mortality was assessed at 48 h after incubation at 25° C. The insect cadavers were dissected under the microscope (15×) to check if nematode infection occurred. Each treatment consist of three plates as replicates, and the experiment was repeated in two trials.

To further evaluate the effect of UV radiation on virulence of IJs, the numbers of nematodes that invaded G. mellonella were determined in TiO₂-based formulation versus water control after exposing IJs to UV treatment for 0, 10 or 20 min. The IJ suspensions in water or TiO₂ formulation were prepared in the concentration of 1000 IJs/ml following the same procedure as above. Approximately 1 ml of IJ suspension was transferred to the center of 60-mm Petri dish lid, which was placed under UV light for 10 or 20 min in addition to no-UV treatment. Then, the dishes were incubated at 25° C. for 24 h before inoculating G. mellonella. Ten insects were used in each of six dishes as experimental units for treatment repetitions. Insect mortality was assessed at 3 days after inoculation, and dead insects were dissected to count the number of nematodes that invaded each of 10 insects per dish; samples not dissected promptly were frozen for temporary storage and thawed when dissection occurred later. There were a total of 60 insects dissected for each treatment.

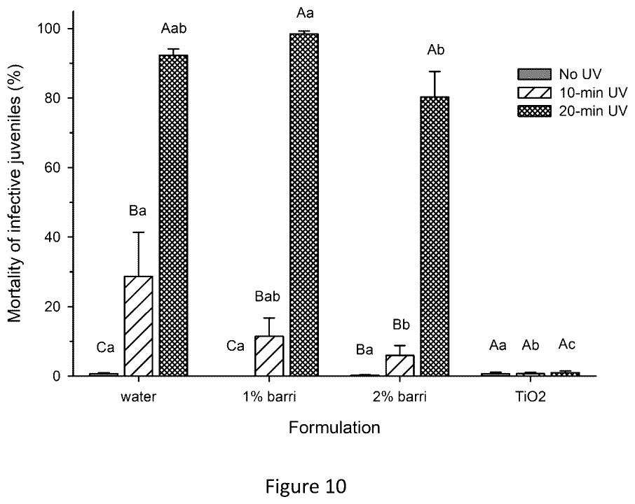

In the effect of UV radiation on IJ viability, IJs mortality varied significantly with formulation (F=22.65, df=3, 96, P<0.0001) and UV exposure time (F=90.33, df=2, 96, P<0.0001); there was significant interaction between formulation and time length of UV treatment (F=14.86, df=6, 96, P<0.0001) (FIG. 10). The IJ mortality increased significantly after 10-min UV radiation except 2% Barricade and the TiO2-based formulations of the invention and increased further after 20-min UV except TiO2-based formulations of the invention, which had 99% viability even after 20-min UV; 20-min UV was more detrimental to IJs than 10-min UV. For 10-min UV, aqueous IJs had the highest mortality, followed by 1% Barricade; 2% Barricade and TiO2-based formulations of the invention, which had almost no dead IJs (<1% mortality). After 20-min UV, IJs mixed with 1% Barricade had the highest mortality, not significantly different from aqueous IJs, and IJs encapsulated within the TiO2-based formulations of the invention still had the lowest IJ mortality (1%).

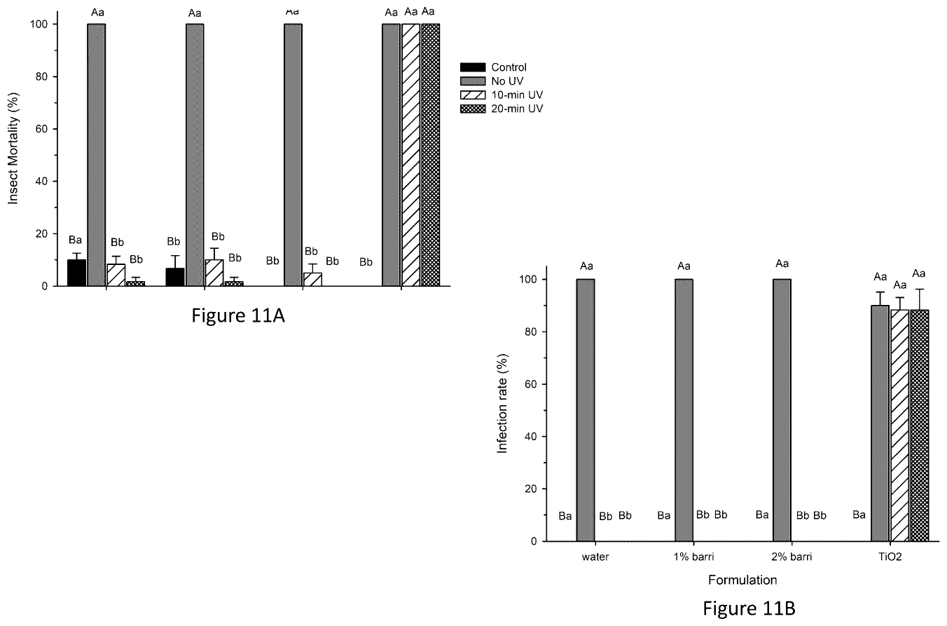

The UV radiation significantly affected the virulence of IJs (F=85.94, d.f.=3, 80, P<0.0001), and the level of effect varied with formulations (F=48.21, d.f.=3, 80, P<0.0001), in causing insect mortality. There were significant interactions between UV exposure time and formulation (F=18.11, d.f.=9, 80, P<0.0001) (FIG. 11A). All formulations had 100% insect mortality for IJs without UV treatment. After UV treatment of 10 or 20 min, insect mortality significantly declined in all formulations except the TiO₂-based formulations of the invention; IJs in those formulations did not have higher mortality than the formulation controls regardless of UV exposure time (except no-UV treatment), while IJs in TiO₂ based formulations of the invention still caused 100% insect mortality even after 20-min UV. Comparing formulations, TiO₂ based formulations of the invention had higher insect mortality than other formulations at both 10 and 20-min UV, whereas other formulations had no difference from each other including aqueous IJs. Formulation controls did not cause significant insect mortality comparing with water.

Most dead insects showed nematode infection by dissecting the cadavers. Being consistent with mortality, IJ infection levels also varied significantly with formulation (F=31.17, d.f.=3, 80, P<0.0001) and UV exposure time (F=60.75, d.f.=3, 80, P<0.0001), which had significant interactions (F=12.12, d.f.=9, 80, P<0.0001) (FIG. 11B). Without UV radiation, all formulations mixed with IJs caused nearly 100% infection. The TiO₂-based formulation of the invention still had 88% infection after 10 or 20-min UV, which did not decline comparing with no-UV treatment (90%). All other formulations did not show IJ infection after UV exposure.

### Effect of UV Radiation on Nematodes Invading Insects

Similar to the previous test, in TiO₂-based formulation of the invention, neither insect mortality (F=0.00, d.f.=2, 30, P=1.0000) nor infection rate (F=0.11, d.f.=2, 30, P=0.8986) declined after UV radiation for 10 or 20 min; all insects died regardless of UV treatment, with an infection rate ≥95%.

In counting the number of nematodes invading insects after dissection, there were no difference between IJs in water control and TiO₂ based formulations of the invention for no-UV treatment (F=0.18, d.f.=1, 118, P=0.6738).

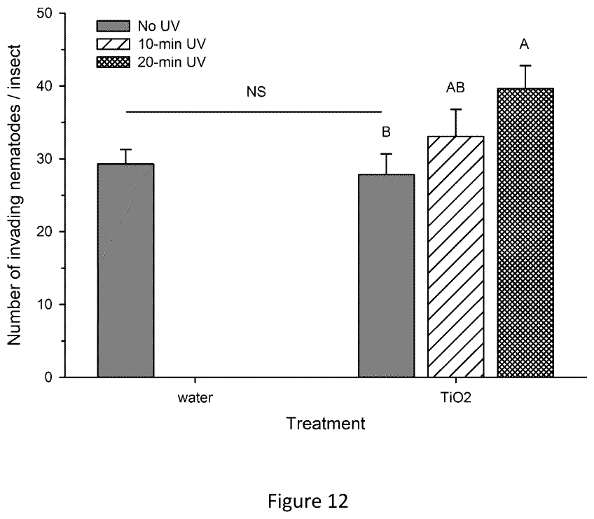

However, no insects died after inoculation with IJs in water after 10 and 20-min UV, and there were no nematodes successfully invading the hosts. Surprisingly, for TiO₂ based formulations of the invention, being consistent with infection, it was found that the numbers of invading nematodes did not decrease after 10 or 20-min UV comparing with no-UV treatment; rather, higher numbers of nematodes were recovered after 20-min UV than no-UV (F=3.18, d.f.=2, 177, P=0.0439) (FIG. 12).

EPNs Activity Against G. mellonella in TiO₂—NH₂ Emulsions

The infectivity of S. carpocapsae IJs in TiO₂—NH₂ Pickering emulsions on G. mellonella was recorded for insect mortality at 48 hours (Table 1). Results indicate that rate of mortality of 5^{th} instar G. mellonella by nematodes in water and TiO₂—NH₂ Pickering emulsions (4:6 and 5:5) were significantly different at 48 hours (P<0.001). However, among treatments, no statistically significant differences were recorded (P>0.05), indicating no adverse effects of the treatment on IJ activity. Additionally, no differences in mortality were observed between control (water only) and emulsions only treatments. This indicates that mortality in emulsion treatments were due to IJ penetration.

Table 1: Insect mortality (%) by Steinernema carpocapsae in water, 2% TiO₂—NH₂ emulsions at 4:6 and 5:5 concentration of oil and water on 5^{th} instar larvae of Galleria mellonella, 48 hours post inoculation. The numbers represent the cumulative average of 3 biological replicates. Insect mortality (%) (n=120) were arcsine square-root transformed and subjected to two-way ANOVA. When ANOVA F was significant (p<0.05), means were compared. Means were compared using Tukey HSD test.

| | | Statistical |
|---|---|---|
| | | significance |
| | Insect mortality | (Tukey Kramer |
| Sample name | (% ± SD) | HSD) |
| Control: Only water | 1.33 ± 2.98 | B |
| Control: Only emulsion 4:6 | 2.67 ± 5.96 | B |
| Control: Only emulsion 5:5 | 1.33 ± 2.98 | B |
| S. carpocapsae in water | 100 ± 0.00 | A |
| S. carpocapsae in Titanium | 98.67 ± 2.98 | A |
| emulsion 4:6 | | |
| S. carpocapsae in Titanium | 98.67 ± 2.98 | A |
| emulsion 5:5 | | |

Yield Per G. mellonella Larvae

The emerging IJs were collected and the number of emerged IJs were determined by survival. Emulsion's volume ratio did not have an effect on the number of emerged IJs and was found to be not significantly different in comparison to control (P>0.05). The number of IJ emergence per larva using emulsions of 40:60, 50:50 oil:water volume ratio and control (nematodes in water) were 64000, 66000, and 50000, respectively (FIG. 9). Formulations displayed great stability and maintained EPNs viability in storage for 120 days.

EPNs were individually coated with TiO2 nanoparticles via oil-in-water Pickering emulsion. Mineral oil-in-water Pickering emulsion were prepared under induction of shear forces by sonicator. The droplets were stabilized by amine-functionalized titanium dioxide (TiO₂—NH₂) NPs. The most stable emulsions with 2% TiO₂—NH₂ at 40:60 and 50:50 oil/water ratios with a lowest droplet size were suitable for nematode formulation. The oil and titania NPs aggregates were detected on the surface of the nematodes before and after drying process at room conditions of 25° C.

Exemplary formulation of the invention enable individual nematode coating by the oil droplets and TiO₂—NH₂ NPs. The shear forces increased the surface area of particles occupying the surface of each oil droplets thereby presenting a significant contact with the EPNs. Full nematode coverage is necessary to prevent dehydration and decrease UV exposure for prolonged periods. We expect that this coating can protect nematodes from additional external weather conditions in the field (temperature, moisture, UV, desiccation) more effectively than other formulations. Stability and droplet characteristics of this formulation are easily tunable by proper altering of NPs concentration and oil-in-water ratio. Our developed formulation is low-cost, easy to prepare and to apply, sustainable for the environment, and suitable for large EPN scale-up operations. According to our results the nematodes were preserved in this formulation in 4° C. and 23° C. during a long time. This formulation was found to be biocompatible with the studied nematodes where their viability over time, infectivity and rate of emergence from cadavers was equivalent to aqueous solvent.

### Example 4

Formulation and Survival of EPNs in Pickering emulsion after foliar application The inventor examined the survival of IJs on cotton foliage and in water, the TiO2-based and SiO2-based formulation of the invention extended the survival of IJs from 14 h to >40 h and >80 h, respectively. Under field conditions, the SiO2-based formulation of the invention extended the survival of IJs from 2 h to 8 h.

### Materials and Methods

### Nematodes Source and Culture

S. carpocapsae were cultured on last instar Galleria mellonella. The cadavers were transferred to White traps and collected for IJ emergence post 10 days from infection, filtered and used for further evaluations. The EPN species for initial screening examined were S. carpocapsae and S. feltiae.

### Insects Source and Culture

Galleria mellonella Colony:

Galleria mellonella larvae were reared in sterilized glass jars at ARO, Volcani

Center. The larvae were fed every 2 days and split to avoid overcrowding and the development of disease. Jars were maintained in a 25±2° C. chamber, with a 12:12 hour light regime and an air drier to maintain low humidity.

Spodoptera littoralis Colony:

S. littoralis B. insect colony was continuously maintained at ARO, Volcani Center. Spodoptera littoralis was chosen as a model foliar pest, as it is a polyphagous lepidopteran foliar pest with agricultural relevance. The colony was reared in an insectarium with 25±2° C. and a photoperiod of 12:12 (light:dark). To ensure homogenous development, the 4^{th} instar larvae stage were used, 16-19 days post-hatching.

### Preparation of the Titania-NH2 Pickering Emulsion (TPE):

Pickering emulsions were prepared as disclosed herein, specifically titania-NH₂ NPs were sonically dispersed in deionized water for 5 min (Sonics VibraCell 750 W, 25% amplitude) at titania-NH₂ contents of 1 wt %. Next, mineral oil was added at oil/water ratios of 4:6 by volume, respectively. The mixture was subjected to sonication for 10 min to achieve emulsification (Sonics Vibra-Cell 750 W, 35% amplitude).

### Preparation of Silica Pickering Emulsion Gel (SPEG):

Pickering emulsions were prepared from commercial hydrophobic silica (Aerosil R972, fumed silica treated with dimethyldichlorosilane with an estimated primary particle size of 16 nm, obtained from Evonik, Germany) in paraffin oil and water (Sigma-Aldrich, analytical grade). First, silica NPs were dispersed in paraffin oil by sonication for 5 min (Sonics Vibra-Cell 750 W, 25% amplitude) with a silica content of 0.5 wt %. The 0.5% potassium polyacrylic acid (PPA) in water was added at the W/O ratio of 40:60 by volume. Then the mixture was sonicated for 10 min for emulsification. For 0.5% potassium polyacrylic acid (PPA) polymer solution, 0.5 g of PPA was added to 99.5 mL of water and stirred for 1-2 h for complete dissolution.

Formulating EPNs IJs with Pickering Emulsions:

S. carpocapsae IJs were collected from modified White traps. The emerging IJs were vacuum filtered, suspended in distilled water, and adjusted to a concentration of 1000 nematodes/ml. IJs were suspended in various formulations by centrifuging at 4000 g for 2 min, and the supernatant was discarded. An equal volume of the formulation was added to the nematode and mixed by gentle agitation to create a uniform suspension. Two types of formulations were evaluated, Titanium Pickering emulsion (TPE) and novel Silica Pickering emulsion Gel (SPEG).

Plant experiments were conducted on cotton plants. Cotton plants of the Akala variety were cultivated in pots, maintained in a greenhouse at ambient conditions for 3 months, and used for experiments on nematode survival and efficacy.

### Screening of EPN Species on Cotton Plants:

Infective juveniles of S. carpocapsae and S. feltiae were vacuum filtered, suspended in distilled water, and adjusted to a concentration of 1000 nematodes/ml. The IJs were sprayed on cotton leaves held at 24-26° C. with varying humidity (50-70% RH). Temperature and humidity were monitored using data loggers (SSN23E). Samples (leaves; one leaf/technical repeat) were collected in intervals of an hour on Petri plates with 7 ml tap water, incubated overnight (to let complete revival of IJs), and survival was estimated. Incubated leaves were washed to remove IJs from the leaves. The Petri plates with water were used to count the total IJs survival under binocular (Olympus, SZH10, 30× magnification). Nematodes with active motility or response to probing were scored alive. The surface area of leaves was calculated using Image J software. The total number of live nematodes were normalized to the surface area of the leaf. Experiments were repeated at least twice, with five technical replicates per experiment. Following, initial screening of EPN species, S. carpocapsae were used for further experiments.

### Evaluation of Formulated EPNs at Controlled Conditions:

15 ml of nematodes in water (control) and nematodes in TPE and SPEG formulations ( ) were applied on cotton leaves using hand sprayers. All treatments were incubated in chambers with controlled temperatures and humidity ranging from 25.4±0.7° C., 82±6.2% RH for experiment 1 and 24.3±3° C. and 72.5±6% RH for experiment 2. The experiments were combined as no significant difference between experiments was observed (wald p value=0.88). Samples (leaves; one leaf/technical repeat) from each treatment were collected at 24 h intervals (0 h, immediately after application, 24 h, 48 h, 72 h, and 96 h post-application). Leaves were evaluated for nematode survival as described hereinabove. Nematodes with active motility or response to probing were scored alive. Temperature and humidity were monitored using data loggers (SSN23E). Experiments were repeated twice with five replicates per experiment.

### Insect Bioassays:

The activity of nematodes towards 4^{th} instar S. littoralis B was examined by spraying nematodes on cotton plants. Cotton plants were treated with formulated nematodes, and the activity was compared to cotton plants treated with nematodes, water, TPE and SPEG. Foliage samples (leaves) were collected in 24 h intervals 0 h, immediately after application, 24 h, 48 h, 72 h, and 96 h post-application. The samples were placed in 90 mm Petri plates padded with moist Whatman filter paper. Five larvae were added, plates were covered with lids, sealed with Parafilm, and incubated at 23±1° C. Mortality was assessed after 48 hrs. Each treatment contained five repeats, and the whole experiment was repeated twice.

### EPN Deposition as a Function of Persistence:

The deposition is identified as the coverage/retention of EPN IJs on leaves after application, a skilled in the art will appreciate that enhanced sticking and deposition are prerequisites to increase the efficacy of EPNs on foliar application. To identify the pattern of IJ deposition as a function of persistence/cm², the ratio between the number of survived IJs and leaf surface area were calculated, which yielded the number of survived IJ/cm².

### Evaluation of Formulated EPNs at Greenhouse Conditions:

EPNs (S. carpocapsae) were prepared, applied on cotton leaves, and evaluated for nematode survival and efficacy, in an uncontrolled greenhouse where temperature and humidity were continuously monitored using a data logger (SSN23E). The range of temperatures for experiment 1, 2 were 25.7-34.4° C. and 31.6-37.5° C. respectively. Range of relative humidities for experiment 1, 2 were 44-66.8% RH and 46.5-63.1% RH respectively. Experiments were repeated twice with five technical repeats per treatment for survival and distribution.

### Statistical Analysis

All statistical analyses were performed using JMP version 16 pro (SAS Institute Inc.). Comparisons of survival (%) (n=150) were carried out on the arcsine-transformed proportions of live nematodes. They were subjected to an analysis of standard least squares by restricted maximum likelihood (REML) followed by Student's t-test for multiple comparisons among means. When ANOVA F was significant (p<0.05), means were compared. Insect mortality (%) data was compared by standard least squares by REML method followed by Student's t test for multiple comparisons among means. The means were further compared among time points, and Bonferroni correction (α=0.003) were applied. In addition, the results for efficacy in uncontrolled greenhouse conditions are represented as the mean of replicates from a single experiment. Insect mortality (%) data was compared by standard least squares by REML method followed by Student's t test for multiple comparisons among means. For survived IJs on the leaf area, the number of live IJs were normalized to the surface area of the leaf. This normalized data were subjected to ANOVA with multiple comparisons among means by student's t-test, where the leaf's surface area was considered a random measure throughout biological replicates. LT₅₀ of survival was analyzed by the Probit 4P model and an inverse prediction for the % survival data. Comparisons of slopes were carried out by considering time as a continuous factor.

### Evaluation of IJs Survival on Cotton Leaf Surface Over Time

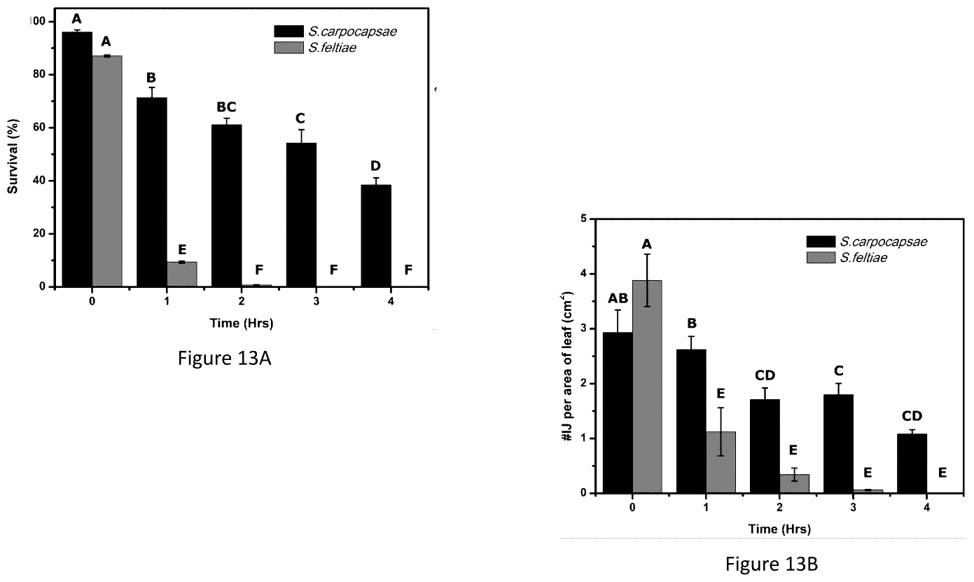

The survival and distribution of live nematodes normalized to the leaf area, of IJs of S. carpocapsae compared to S. feltiae suspended in water on cotton plants were significantly different (F_{(1,138)}=345.5660; P<0.0001, and p=0.0084, respectively). The survival of S. carpocapsae was about 6 times higher than the survival of S. feltiae (F_{(4,138)}=99.0602; P<0.0001) (FIG. 13A). Two hours post-application, the survival of S. feltiae was less than 5%, whereas after 4 h the survival of S. carpocapsae was about 50%.

Although both species observed a general decline in the deposition of nematodes on leaves over time, the live nematodes on the leaves were significantly higher for S. carpocapsae in comparison to S. feltiae (F_{(1, 133.9)}=40.8889; P<0.0001) (FIG. 13B). The LT₅₀ for S. carpocapsae and S. feltiae was 3.08±0.31 and 0.26±0.34 hours, respectively. The comparison in the survival slopes of the nematodes showed that the rate of survival of S. carpocapsae was significantly lower than S. feltiae over time (t (144)=3.92; P=0.0001). The S. feltiae IJs survival percentage showed an abrupt reduction to less than 50% in the first-hour post-application. However, S. carpocapsae exhibited a gradual viability reduction.

### Screening of Formulations for Survival and Efficacy Under Moderate Conditions

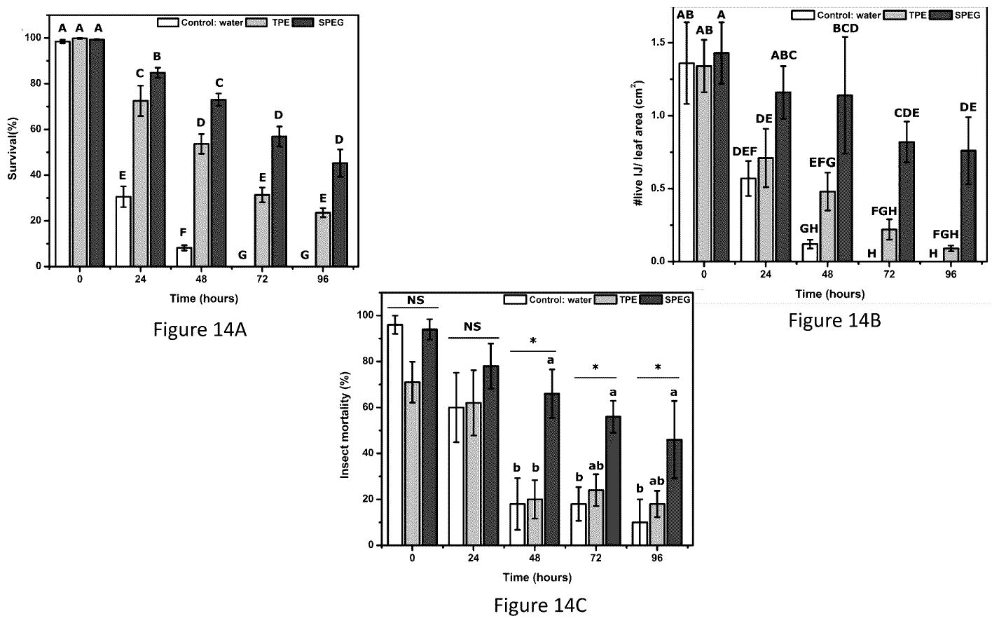

Formulated and non-formulated EPN IJs were applied by spraying on cotton leaves, and their survival and efficacy under moderate condition was examined. FIG. 14A demonstrates the survival of IJs in water (control) and EPN IJs formulated in SPEG and TPE, wherein the control was significantly lower than formulated IJ in TPE and SPEG after 24 h and longer (F_{(2,134)}=215.8536; P<0.0001). In addition, SPEG formulations retained the survival of IJ over 96 hours very effectively compared to TPE (F_{(1,134)}=14.9131; P=0.0002). Although, the number of survived IJ/cm² in SPEG was significantly higher than the control (F_{(3,129.8)}=15.0720; P<0.0001) for 48-96 hours. TPE and water were not statistically significant at the same time points (F_{(3,129.4)}=1.7006; P>0.05) (FIG. 14B). In particular, the number of survived IJ/cm² is ca. 3 times higher in SPEG compared to the control and TPE at the measured time points. The LT50 of water, TPE, and SPEG were 14±2.41, 49±3.37, and 85±7.05 h, respectively. The survival of IJ in SPEG and TPE was 6 times and 3 times higher in comparison to the control, respectively. Comparison of slopes indicated that the slopes of water, and IJ in TPE were not statistically significant (t (143)=0.40; P=0.6933) while water and IJ in SPEG were statistically significant (t (143)=−4.63; P=<0.0001). However, the slopes of IJ in TPE and IJ in SPEG were not statistically significant (t (143)=0.40; P=0.6933), indicating that the rate of change of nematodes in SPEG over time is slow in comparison to TPE and water. The infectivity of EPN IJs was retained for 96 hours by SPEG and was significantly higher in comparison to the control (F_{(2,134)}=5.2478; P=0.0064) (FIG. 14C). At 48-96 hrs, EPNs protected in SPEG exhibited a ca. 3.5-4× fold increase in infectivity in comparison to water. Thus, the efficacy of the IJ was retained throughout the environmental condition.

### Effect of Formulations for Survival and Efficacy in Extreme Greenhouse Conditions

Formulated and non-formulated EPN IJs applied by spraying on cotton leaves and their survival and efficacy in extreme greenhouse conditions were examined. The survival of IJs in water (control) and IJs in SPEG and IJs in TPE. was significantly lower than the formulated IJs samples (F_{(2,107)}=106.6484; P<0.0001). IJs formulated in SPEG and in TPE retained the IJs survival in the 8 h, the experiments was conducted. SPEG was more effective than TPE; hence, the survival of IJs in SPEG was significantly different in comparison to TPE (F_{(4,107)}=17.3201; P<0.0001). After 2 h, survival of IJs in water, IJs in SPEG and IJs in TPE was about 30%, about 90%, and about 70%, respectively. Considering the extreme environmental conditions, both formulations moderately protected EPN IJs, however SPEG formulation retains at least a 2-fold higher number of live nematodes per cm² for 4 hours than control and TPE.LT₅₀ values for nematodes applied in water, TPE, and SPEG were 1.53±0.26, 3.13±0.22, and 6.54±1.33 hours respectively.

The inventors successfully integrated EPNs (i.e., S. carpocapsae and S. feltiae) against target foliar pests (i.e., Galleria mellonella) by formulating the nematodes in a protective encasement (Pickering emulsion), thereby increasing the survival and efficacy of the EPNs on foliage. SPEG and TPE formulation extended IJs survival and efficacy from less than 2 h to about 8 h post-application under moderate conditions.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A composition, comprising an entomopathogenic organism coated by a plurality of nanoparticles, wherein the plurality of nanoparticles comprises a UV-shielding nanoparticles, wherein said composition is an aqueous dispersion of said entomopathogenic organism.

2. The composition of claim 1, wherein said UV-shielding nanoparticles are assembled within a core-shell particle; wherein the core-shell particle comprises a liquid core comprising an oil, and wherein the liquid core is enclosed by a shell comprising said plurality of nanoparticles.

3. (canceled)

4. The composition of claim 2, wherein the core-shell particle is characterized by an average particle size between 1 and 50 um.

5. The composition of claim 2, wherein (i) a weight ratio between the plurality of nanoparticles and the oil within said core-shell particle or within said composition is between 1:10 and 1:100; (ii) a w/w concentration of the plurality of nanoparticles within said composition is between 0.1 and 10%; and wherein said UV-shielding nanoparticles are chemically modified metal oxide particles.

6. (canceled)

7. The composition of claim 5, wherein said metal oxide particles comprise a metal oxide selected from SiO₂, TiO₂ or both; and wherein said chemically modified comprises a functional moiety covalently bound to said metal oxide particles.

8. The composition of claim 7, wherein said metal oxide comprises TiO₂ and said functional moiety comprises any one of: (i) aminoalkyl group, amino group, hydroxyalkyl group, thioalkyl group, aminoalkyl silane group, hydroxyalkyl silane group, thioalkyl silane group, or any combination thereof; (ii) a UV-absorbing group, or both (i) and (ii), optionally wherein said metal oxide is selected from SiO₂ and TiO₂.

9. (canceled)

10. The composition of claim 1, wherein the entomopathogenic organism comprises a nematode; optionally wherein said nematode is an entomopathogenic Infective juvenile nematode.

11. (canceled)

12. The composition of claim 3, wherein said oil is a liquid at a temperature between 1° and 60° C. and is characterized by viscosity at 25° C. between 1 and 100 cP; optionally wherein said oil is any one of: (i) substantially non-toxic to the entomopathogenic organism; (ii) substantially devoid of phytotoxicity.

13. (canceled)

14. (canceled)

15. The composition of claim 3, wherein said oil comprises a mineral oil, a C10-C30 aliphatic hydrocarbon, a fatty acid, a monoglyceride, a diglyceride, a triglyceride, a plant oil, wax, an essential oil, or an aromatic oil, including any combination thereof.

16. The composition of claim 1, wherein said composition is in a form of an emulsion.

17. The composition of claim 1, wherein said composition further comprises a gelation agent; optionally wherein said gelation agent is a polymeric gelation agent comprising a polyacrylic acid, polyvinyl alcohol, polyethylene oxide, polyethylene glycol, poly(2-hydroxyethyl methacrylate), polyacrylamide, or a polysaccharide, including any salt and any combination thereof; optionally wherein a concentration of the gelation agent within the composition is between 0.1 and 10% w/w.

18. (canceled)

19. A pesticide composition comprising the composition of claim 1; wherein the pesticide composition comprises a pesticidal effective amount of the entomopathogenic organism.

20. The pesticide composition of claim 19, formulated for spraying or coating; wherein the pesticidal effective amount comprises a concentration of said entomopathogenic organism being at least 10 units/ml within said pesticide composition.

21. (canceled)

22. (canceled)

23. (canceled)

24. (canceled)

25. (canceled)

26. (canceled)

27. A method for controlling a pest, comprising applying an effective amount of the pesticide composition of claim 19 to at least a portion of a plant, or to an area under cultivation infested with said pest, thereby controlling or reducing growth of said pest.

28. The method of claim 27, wherein said pesticide composition is characterized by adhesiveness to at least a part of said plant wherein said applying comprises any of immersion, soaking, coating, irrigating, dipping, spraying, fogging, scattering, painting, injecting, or any combination thereof; optionally wherein said effective amount is between 1 and 1000 L/ha.

29. (canceled)

30. The method of claim 27, wherein said pest comprises an arthropod; and wherein said arthropod is a plant pest.

31. (canceled)

32. (canceled)

33. (canceled)
